(19) United States
(12) Patent Application Publication
(10) Pub. No.: US 2016/0055313 A1
(43) Pub. Date: Feb. 25, 2016

(54) Method and System For Recommending Prescription Strings

(71) Applicant: DrFirst.com, Inc., Rockville, MD (US)

(72) Inventor: David Andrew Sellars, Zanesfield, OH (US)

(21) Appl. No.: 14/466,663

(22) Filed: Aug. 22, 2014

(51) Int. Cl. G06F 19/00

(52) U.S. Cl. CPC G06F 19/3456

(57) ABSTRACT

Methods, systems and programming for generating and/or recommending prescription strings are presented. In one example, data related to a medication drug are obtained. One or more candidate prescription strings are identified from the obtained data. Each of the candidate prescription strings is associated with a plurality of attributes. Each of the one or more candidate prescription strings is automatically processed based on at least one model to generate one or more prescription strings each with an associated ranking. At least some of the generated one or more prescription strings and the associated rankings are stored for future use.

### TECHNICAL FIELD

The present teaching relates to methods, systems and programming for health care. More specifically, the present teaching relates to methods, systems, and programming for computer aided prescription.

### BACKGROUND

A prescription is an order issued by qualified practitioners, such as physicians, nurse practitioners, dentists, pharmacists, psychologists, and other health care providers, to prescribe drugs to their patients. A prescription often includes information related to a drug and directions for a patient to follow when taking the drug.

A prescription string may include a plurality of fields each representing an attribute associated with the prescription. FIG. 1 (Prior Art) illustrates an interface via which a user generates a prescription string with multiple actions, according to a prior art example. As shown in FIG. 1, a user, e.g. a physician, inputs a medication 102 and a corresponding strength 104. After that, the user is provided with a plurality of fields 111-119 for the user to select an element from each field. To generate a prescription string, the user has to fill in multiple fields of the prescription string by, e.g., clicking on at least nine elements as illustrated in FIG. 1. As the number of clicks required for generating a prescription string increases, the time and cost for the physician increase as well. In addition, since traditional systems rely on the user to manually fill in the fields to create a prescription string, each field introduces an opportunity for human error. Thus, even though current systems allow a user to use a computer to assist in generating a prescription string, because the current systems require the user to perform multiple actions during the process, it is not only error prone but also inefficient.

Therefore, there is a need to provide a solution for a more efficient approach for generating prescription strings to avoid the above-mentioned drawbacks.

### SUMMARY

The present teaching relates to methods, systems and programming for health care. More specifically, the present teaching relates to methods, systems, and programming for computer aided prescription.

In one example, a method, implemented on at least one computing device each of which has at least one processor, storage, and a communication platform connected to a network for generating prescription strings is presented. Data related to a medication drug are obtained. One or more candidate prescription strings are identified from the obtained data. Each of the candidate prescription strings is associated with a plurality of attributes. Each of the one or more candidate prescription strings is automatically processed based on at least one model to generate one or more prescription strings each with an associated ranking. At least some of the generated one or more prescription strings and the associated rankings are stored for future use.

In another example, a method, implemented on at least one computing device each of which has at least one processor, storage, and a communication platform connected to a network for recommending prescription strings is presented. A request is received for recommending a prescription string. The request is resulted from a single action of a user and associated with a least one parameter. At least one prescription string stored previously is identified. Each of the at least one prescription string has a plurality of attributes that match with the at least one parameter. The at least one prescription string is provided as recommendation for the request.

In yet another example, a system having at least one processor, storage, and a communication platform for generating prescription strings is presented. The system includes a data analyzer, an analytic engine, and a re-contextualizing unit. The data analyzer is configured to obtain data related to a medication drug and identify one or more candidate prescription strings from the obtained data. Each of the candidate prescription strings is associated with a plurality of attributes. The analytic engine is configured to automatically process each of the one or more candidate prescription strings based on at least one model to generate one or more prescription strings each with an associated ranking. The re-contextualizing unit is configured to store at least some of the generated one or more prescription strings and the associated rankings for future use.

In a different example, a system having at least one processor, storage, and a communication platform for recommending prescription strings is presented. The at least one processor is configured to receive a request for recommending a prescription string. The request is resulted from a single action of a user and associated with a least one parameter. The at least one processor is configured to identify at least one prescription string stored previously. Each of which has a plurality of attributes that match with the at least one parameter. The at least one processor is configured to provide the at least one prescription string as recommendation for the request.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 (Prior Art) illustrates an interface of a prior art system via which a user can generate a prescription string;

FIG. 2 illustrates a user interface via which a user can generate a prescription string via a single action, according to an embodiment of the present teaching;

FIG. 3 is a high level depiction of an exemplary networked environment for prescription string generation and recommendation, according to an embodiment of the present teaching;

FIG. 4 is a high level diagram illustrating a feedback loop between users and the system for prescription string generation and recommendation, according to an embodiment of the present teaching;

FIG. 5 illustrates an exemplary diagram of an analytic engine for prescription string generation, according to an embodiment of the present teaching;

FIG. 6 is a flowchart of an exemplary process performed by an analytic engine for prescription string generation, according to an embodiment of the present teaching;

FIG. 7 illustrates an exemplary normalization model in an analytic engine, according to an embodiment of the present teaching;

FIG. 8 illustrates another exemplary normalization model in an analytic engine, according to an embodiment of the present teaching;

FIG. 9 illustrates yet another exemplary normalization model in an analytic engine, according to an embodiment of the present teaching;

FIG. 10 illustrates an exemplary diagram of a data normalizer in an analytic engine, according to an embodiment of the present teaching;

FIG. 11 is a flowchart of an exemplary process performed by a data normalizer, according to an embodiment of the present teaching;

FIG. 12 illustrates an exemplary ranking model in an analytic engine, according to an embodiment of the present teaching;

FIG. 13 illustrates an exemplary diagram of a ranking unit in an analytic engine, according to an embodiment of the present teaching;

FIG. 14 is a flowchart of an exemplary process performed by a ranking unit, according to an embodiment of the present teaching;

FIG. 15 illustrates functions that can be performed by a quality control unit in an analytic engine, according to an embodiment of the present teaching;

FIG. 16 illustrates an exemplary diagram of a quality control unit in an analytic engine, according to an embodiment of the present teaching;

FIG. 17 is a flowchart of an exemplary process performed by a quality control unit, according to an embodiment of the present teaching;

FIG. 18 illustrates functions that can be performed by a re-contextualizing unit in an analytic engine, according to an embodiment of the present teaching;

FIG. 19 illustrates a hierarchical structure for a drug from a drug concept to a prescription string, according to an embodiment of the present teaching;

FIG. 20 illustrates an exemplary diagram of a re-contextualizing unit in an analytic engine, according to an embodiment of the present teaching;

FIG. 21 is a flowchart of an exemplary process performed by a re-contextualizing unit, according to an embodiment of the present teaching;

FIG. 22 illustrates different methods for retrieving prescription strings, according to various embodiments of the present teaching;

FIG. 23 illustrates an exemplary prescription string, according to an embodiment of the present teaching;

FIG. 24 illustrates a cloud based network environment for a deployment engine, according to an embodiment of the present teaching;

FIG. 25 illustrates an exemplary diagram of a deployment engine, according to an embodiment of the present teaching;

FIG. 26 is a flowchart of an exemplary process performed by a deployment engine, according to an embodiment of the present teaching;

FIG. 27 illustrates another exemplary diagram of a deployment engine, according to another embodiment of the present teaching;

FIG. 28 is a flowchart of another exemplary process performed by a deployment engine, according to another embodiment of the present teaching;

FIG. 29 illustrates yet another exemplary diagram of a deployment engine, according to another embodiment of the present teaching;

FIG. 30 is a flowchart of yet another exemplary process performed by a deployment engine, according to another embodiment of the present teaching;

FIG. 31 depicts a general mobile device architecture on which the present teaching can be implemented; and

FIG. 32 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present teaching describes methods, systems, and programming aspects of automatically generating and recommending prescription strings to users. The users may include personnel in hospitals, clinics, and/or other health care facilities who are authorized to prescribe medication to patients.

According to various embodiments of the present teaching, a prescription string recommending system is disclosed. The disclosed system is capable of collecting data related to a medication drug from different sources including but not limited to pharmaceutical companies, researchers, and Food and Drug Administration (FDA). The disclosed prescription string recommending system identifies candidate prescription strings from the collected data and automatically processes the candidate prescription strings to generate a subset of prescription strings that are considered to be useful for future use. Each of the prescription strings in the subset is associated with a ranking determined by the system. The subset of prescription strings is stored in a database. Based on a schedule associated with a user or upon a request from a user, e.g., a physician, the prescription string recommending system may then identify one or more prescription strings stored in the database and recommend such identified prescription strings to the user. The set of prescription strings recommended to the user are selected based on their rankings computed according to a model.

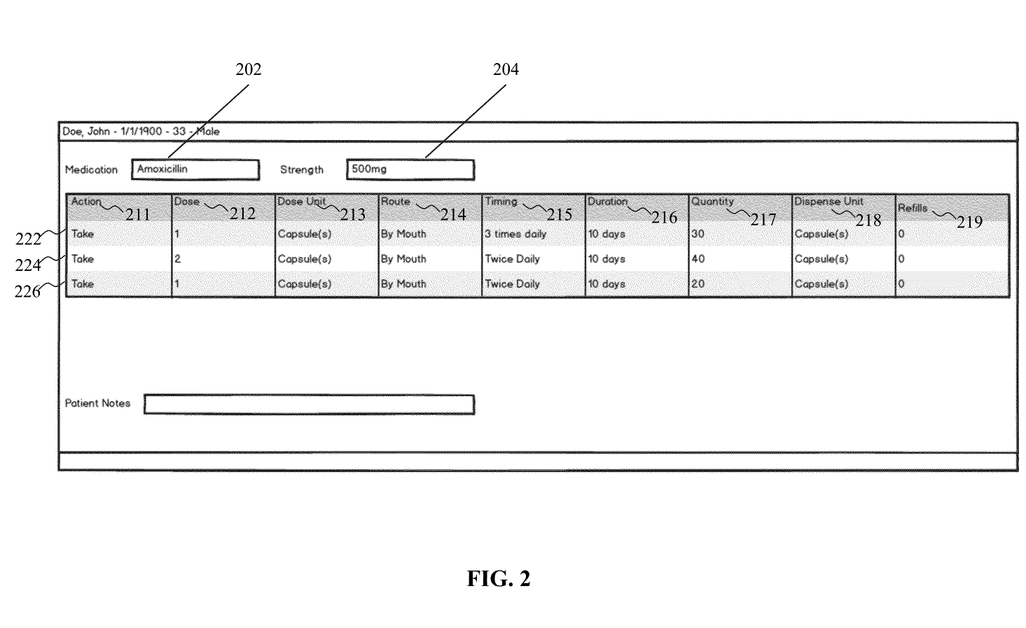

Using the disclosed prescription string recommendation system, a physician who desires to prescribe a drug to a patient, can generate a prescription string via a single action, such as a mouse click, based on the received prescription strings recommended by the prescription string recommending system. FIG. 2 illustrates a user interface via which a user can generate a prescription string via a single action, according to an embodiment of the present teaching. As shown in FIG. 2, after a user, e.g. the physician, inputs the name of a medication 202 and a corresponding strength 204, the user is provided with a list of prescription strings 222-226, each of which is associated with a ranking, received from the prescription string recommending system disclosed herein. Each of the recommended prescription strings includes a plurality of fields 211-219, each of which has been automatically populated, by the prescription sting recommendation system, at the time of recommendation. As such, it prevents human errors and improves the efficiency. In this case, to commit to a prescription string for the patient, the physician needs merely selecting one of the ranked prescription strings via a single action, e.g. clicking on one of the prescription strings 222-226 shown in FIG. 2. In this manner, the number of actions required for generating a prescription string is minimized, which can thus save time and cost associated with the physician. In addition, as the prescription string recommending system ensures the validity of each of the recommended prescription strings, it greatly reduces the risk of a prescription error.

According to some embodiments of the present teaching, the prescription string recommending system may obtain feedbacks with respect to the recommended prescription strings from, e.g., physician. As such, the feedback information can be used to dynamically evaluate the stored prescription strings and/or their associated rankings so that information feedback from actual usages of drugs can be utilized to continuously improve the effectiveness of the prescription string recommendation system.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

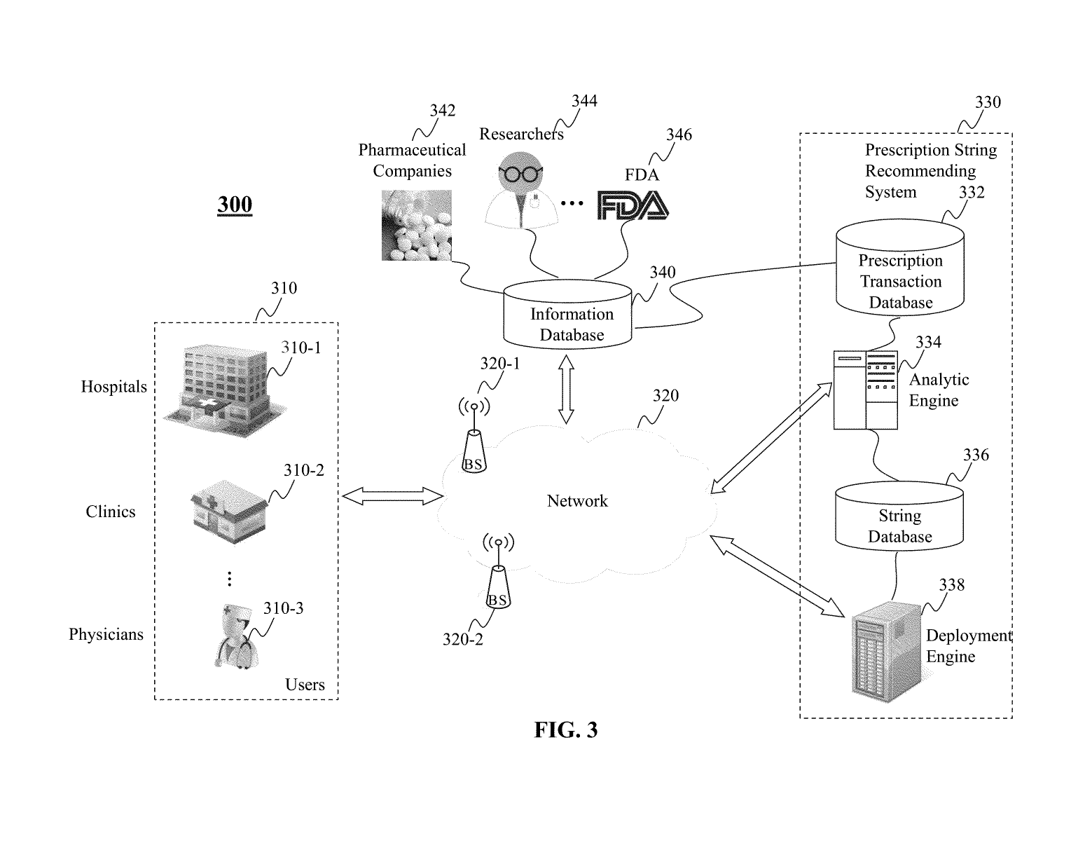

FIG. 3 is a high level depiction of an exemplary networked environment 300 for prescription string generation and recommendation, according to an embodiment of the present teaching. In FIG. 3, the exemplary networked environment 300 includes one or more users 310, a network 320, a prescription string recommending system 330, an information database 340, and one or more sources 342-346 for the information database 340. The prescription string recommending system 330 further includes a prescription transaction database 332, an analytic engine 334, a string database 336, and a deployment engine 338.

The network 320 may be a single network or a combination of different networks. For example, the network 320 may be a local area network (LAN), a wide area network (WAN), a public network, a private network, a proprietary network, a Public Telephone Switched Network (PSTN), the Internet, a wireless network, a virtual network, or any combination thereof. The network 320 may also include various network access points, e.g., wired or wireless access points such as base stations or Internet exchange points 320-1, . . . , 320-2, through which a data source may connect to the network 320 in order to transmit information via the network 320.

Users 310 may be of different types such as users connected to the network 320 via hospitals 310-1, clinics 310-2, or an individual physician 310-3. A user 310-3 may receive recommended prescription strings from the deployment engine 338 in the prescription string recommending system 330 via the network 320. The user 310-3 may perform prescription transactions based on the recommended prescription strings. The information related to prescription transactions including selected prescription strings can be sent back to the prescription string recommending system 330 and stored in the prescription transaction database 332 via the network 320.

The prescription string recommending system 330 may provide different prescription strings to the users 310 and collect feedbacks related to prescription transactions from, e.g., the users 310. Prescription strings recommended by the prescription string recommending system 330 are generated based on prescription transaction data in the prescription transaction database 332. The prescription transaction database 332 may store different types of information. For example, it may store information related to prescription transactions received from, e.g., the users 310. It may also store certain drug-related information, which may be retrieved from, e.g., the information database 340. It may also store information about prescriptions accumulated over time by the prescription string recommending system 330. The information database 340 may store variety types of knowledge about different drugs. For example, it may store information related to the composition or characteristics of different medication drugs, provided by, e.g., pharmaceutical companies 342, research institutions 344, and/or FDA 346.

The analytic engine 334 in the prescription string recommending system 330 may analyze the information stored in the prescription transaction database 332 and generate ranked prescription strings that can be recommended to the users 310. In some embodiments, the generated prescription strings by the analytic engine 334 are first stored in the string database 336. According to a predetermined schedule associated with a user or upon request from a user, the deployment engine 338 may retrieve at least some of the stored prescription strings in the string database 336 and deploy them to the user.

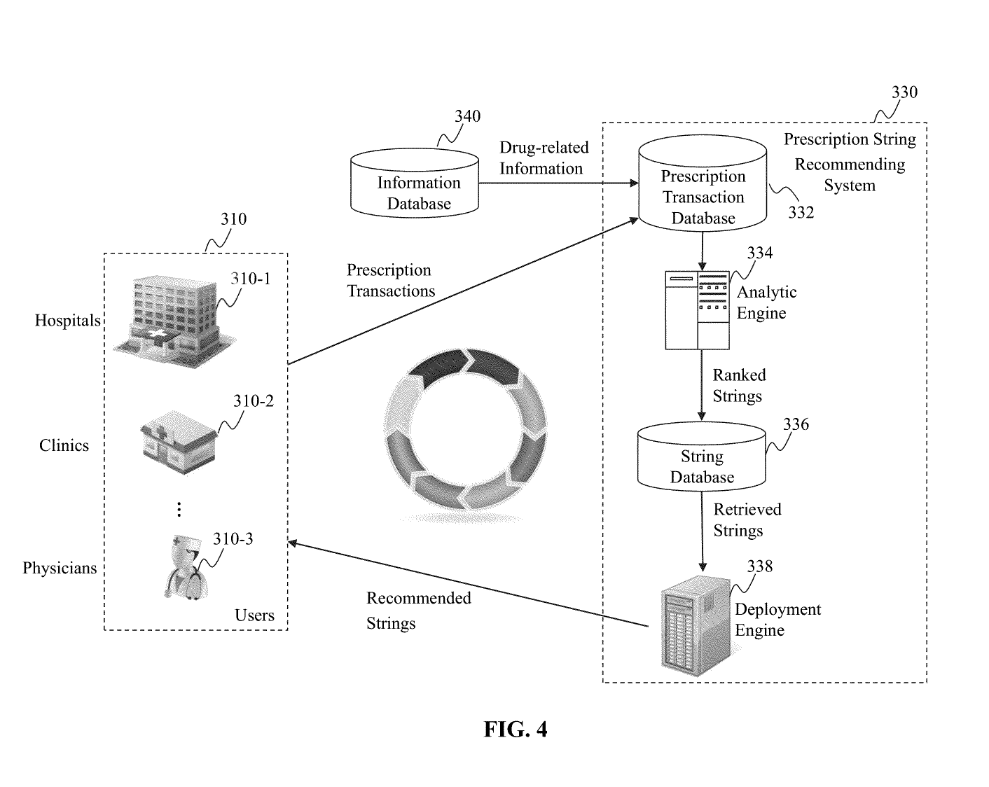

FIG. 4 is a high level diagram illustrating a feedback loop between users and the prescription string recommending system 330 for prescription string generation and recommendation, according to an embodiment of the present teaching. As shown in FIG. 4, prescription transactions from the users 310 and drug-related information from the information database 340 may be fed into the prescription transaction database 332 within the prescription string recommending system 330. This can be performed periodically according to a schedule, e.g. every night. The information stored in the prescription transaction database 332 is retrieved by the analytic engine 334 to generate ranked prescription strings to be stored in the string database 336. At least some of the prescription strings stored in the string database 336 can be retrieved by the deployment engine 338 to form recommended prescription strings. The deployment engine 338 sends the recommended prescription strings to the users 310. Upon a user carries out a prescription transaction based on some recommended prescription strings, e.g. in a manner shown in FIG. 2, the prescription transaction and associated information may be recorded in the prescription transaction database 332 of the prescription string recommending system 330. Thus, a feedback loop is established so that the prescription string recommending system 330 may use such continuous prescription transaction data to dynamically update the stored prescription strings and/or their associated rankings.

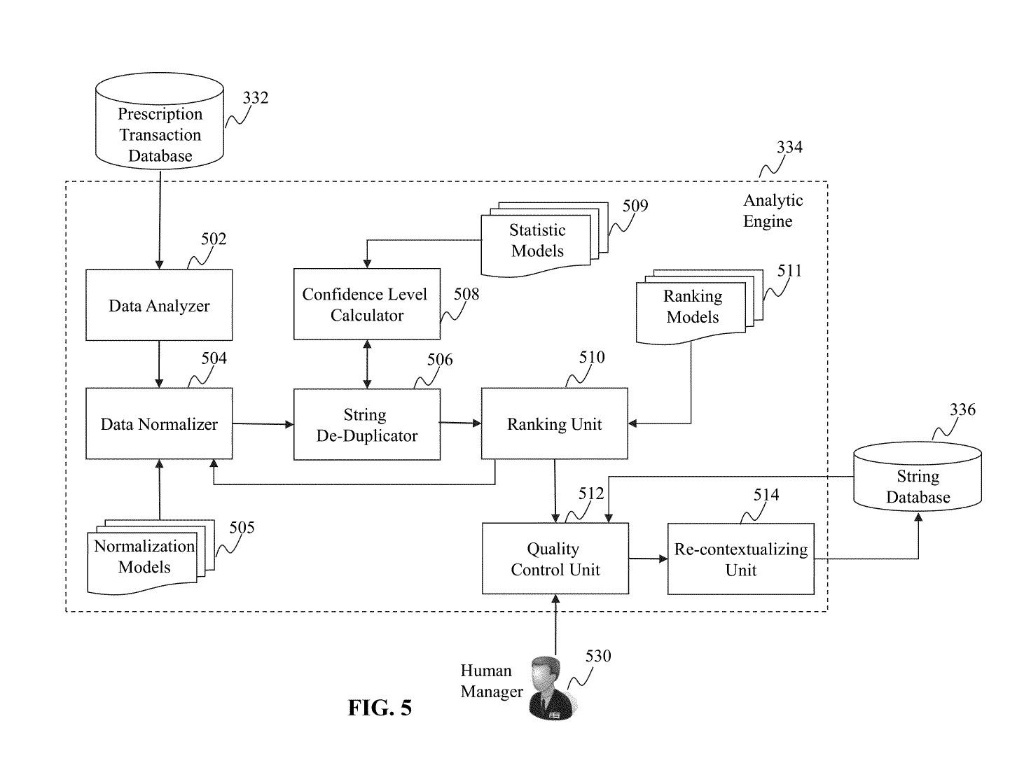

FIG. 5 illustrates an exemplary diagram of an analytic engine 334 for prescription string generation, according to an embodiment of the present teaching. The analytic engine 334 is part of the prescription string recommending system 330 (as shown in FIG. 3). In this exemplary embodiment, the analytic engine 334 includes a data analyzer 502, a data normalizer 504, normalization models 505, a string de-duplicator 506, a confidence level calculator 508, statistic models 509, a ranking unit 510, ranking models 511, a quality control unit 512, and a re-contextualizing unit 514. The analytic engine 334 in this example receives information about prescription transactions from the prescription transaction database 332, generates ranked prescription strings and stores them into the string database 336. In some embodiments, the generated ranked prescription strings may be transmitted directly to the users 310.

In this exemplary embodiment, the data analyzer 502 may retrieve information from the prescription transaction database 332. As discussed before, the information in the prescription transaction database 332 may include data related to one or more medication drugs and/or information related to previous prescription transactions at one of the users 310. The data analyzer 502 analyzes the retrieved information from the prescription transaction database 332 to identify one or more candidate prescription strings. Each of the candidate prescription strings may be associated with a plurality of attributes. For example, as shown in FIG. 2, the attributes can be represented by different fields in a prescription string, including action 211, dose 212, dose unit 213, route 214, timing 215, duration 216, quantity 217, dispense unit 218, and refills 219. The data analyzer 502 sends the identified one or more candidate prescription strings to the data normalizer 504 for processing.

In some embodiments, the data normalizer 504 automatically processes each of the one or more candidate prescription strings based on some normalization models 505. For example, based on some normalization model, the data normalizer 504 may identify new entries from the candidate prescription strings and generate a fuzzy map to match new entries. Other normalization models may also be employed. For example, the data normalizer 504 may identify drug strength and convert the drug strength to a normalized dose unit based on some conversion model. According to yet another normalization model, the data normalizer 504 may obtain dose, frequency, and duration information from the candidate prescription strings and align quantity and duration of the prescription strings.

The normalization models 505 may be pre-configured in the analytic engine 334 for data normalization. Each configuration may also be dynamically adjusted, e.g. based on feedbacks from the users 310. The data normalizer 504 may determine which data should be applied with what normalization scheme. For each prescription string to be normalized, appropriate normalization models are determined and applied accordingly. In some embodiments, the data normalizer 504 may receive certain feedback from, e.g., the ranking unit 510. The data normalizer 504 may then carry out additional normalization processing based on the received feedback.

The string de-duplicator 506 in this example removes duplicate strings from the candidate prescription strings. During the de-duplication process, the string de-duplicator 506 may cooperate with the confidence level calculator 508 to calculate a confidence level of a prescription string based on some given model, e.g., a statistic model. The statistic models 509 may be selected or determined based on a variety of considerations, such as the source of each candidate prescription string, the feedbacks associated with each candidate prescription string, and the likelihood that each candidate prescription string will be recommended to a user. For example, a candidate prescription string generated based on data that was not converted may have a higher confidence level than another candidate prescription string generated based on data that was converted or back calculated. Confidence levels can also be higher when candidate prescription strings pass checks for factors of rationality from FDA. Based on feedbacks from the users 310 and/or predetermined configuration in the analytic engine 334, the confidence level calculator 508 may select a statistic model from the statistic models 509 in the analytic engine 334. Based on the statistic model, the confidence level calculator 508 can calculate a confidence level associated with each candidate prescription string and send the confidence level to the string de-duplicator 506. The string de-duplicator 506 then sends the de-duplicated prescription strings with their confidence levels to the ranking unit 510.

In some embodiments, the ranking unit 510 may rank the prescription strings based on their confidence levels and a ranking model. The ranking model may be selected by the ranking unit 510 from the ranking models 511, e.g. based on feedbacks from users 310. For example, according to one ranking model, a prescription string that has been more frequently selected by users 310 than other prescription strings is ranked higher than other prescription strings. Alternatively, for a new candidate prescription string, if an existing prescription string similar to the candidate prescription string has been more frequently selected by users 310 than other candidate prescription strings, then the candidate prescription string should be ranked higher than other candidate prescription strings. Based on the ranking model, the ranking unit 510 generates a list of ranked prescription strings.

In one embodiment, the ranking unit 510 may send the ranked prescription strings back to the data normalizer 504 to determine whether additional normalization is needed for the ranked prescription strings. In another embodiment, the ranking unit 510 may send the ranked prescription strings back to the quality control unit 512 for quality control.

The quality control unit 512 may control quality of the prescription strings ranked by the ranking unit 510 before they can be stored in the string database 336. The quality control unit 512 can automatically compare each prescription string with previously qualified prescription strings stored in the string database 336. If a match can be found by the comparison, the matched prescription string is automatically qualified. Otherwise, a human review may be requested for the unmatched prescription string. As shown in FIG. 5, a human manager 530 can perform a human review for each unmatched prescription string to determine whether the unmatched prescription string should be qualified. In one example, the human manager 530 is an expert related to prescription strings and associated with the prescription string recommending system 330. The quality control unit 512 receives human reviews from the human manager 530 and determines whether to qualify each unmatched prescription string based on the human review. The quality control unit 512 then sends the qualified prescription strings to the re-contextualizing unit 514.

The re-contextualizing unit 514 in this example re-contextualizes the qualified prescription strings and saves the re-contextualized prescription strings into the string database 336. The re-contextualization may include re-connecting each prescription string with a drug code, e.g. the national drug code (NDC). The re-contextualization may also include generate a nomenclature map with the qualified prescription strings to be consistent with the stored prescription strings in the string database 336.

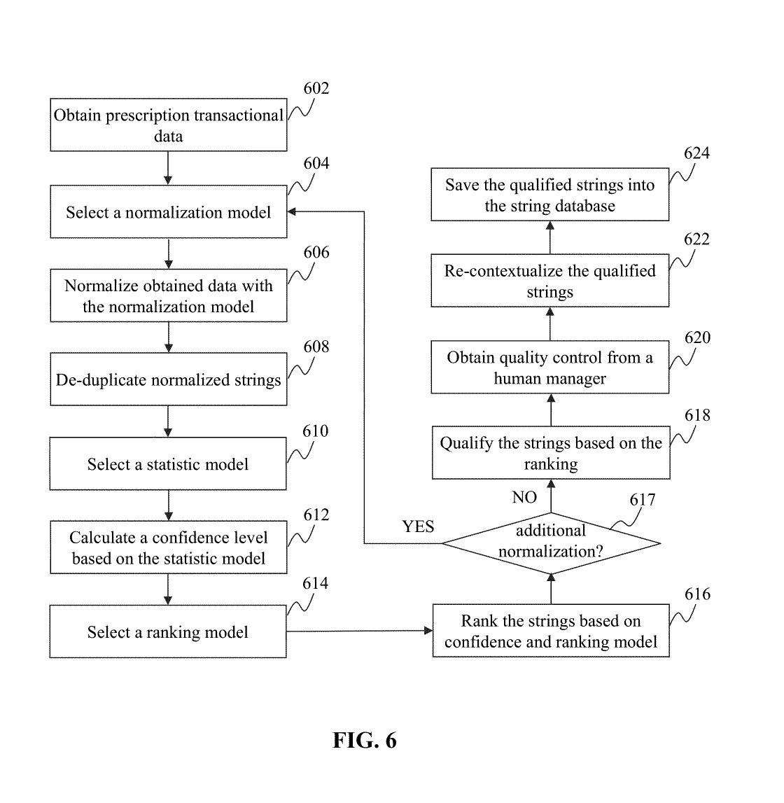

FIG. 6 is a flowchart of an exemplary process performed by an analytic engine, e.g. the analytic engine 334 shown in FIG. 5, for prescription string generation, according to an embodiment of the present teaching. Starting at 602, prescription transactional data are obtained. At 604, a normalization model is selected. At 606, the obtained data are normalized with the normalization model. At 608, the normalized prescription strings are de-duplicated. At 610, a statistic model is selected. At 612, a confidence level is calculated for each prescription string based on the statistic model. At 614, a ranking model is selected. At 616, the prescription strings are ranked based on their confidence levels and the ranking model.

At 617, it is checked whether additional normalization is needed. If so, the process goes back to 604 to select a normalization model for additional normalization. Otherwise, the process goes to 618, where the prescription strings are qualified based on their rankings and/or comparison between each prescription string and pre-qualified or pre-approved prescription strings. At 620, quality control is obtained from a human manager, which may happen when some prescription strings cannot be matched with pre-qualified prescription strings based on the comparison at 618. At 622, the qualified prescription strings are re-contextualized. At 624, the qualified and re-contextualized prescription strings are saved into the string database.

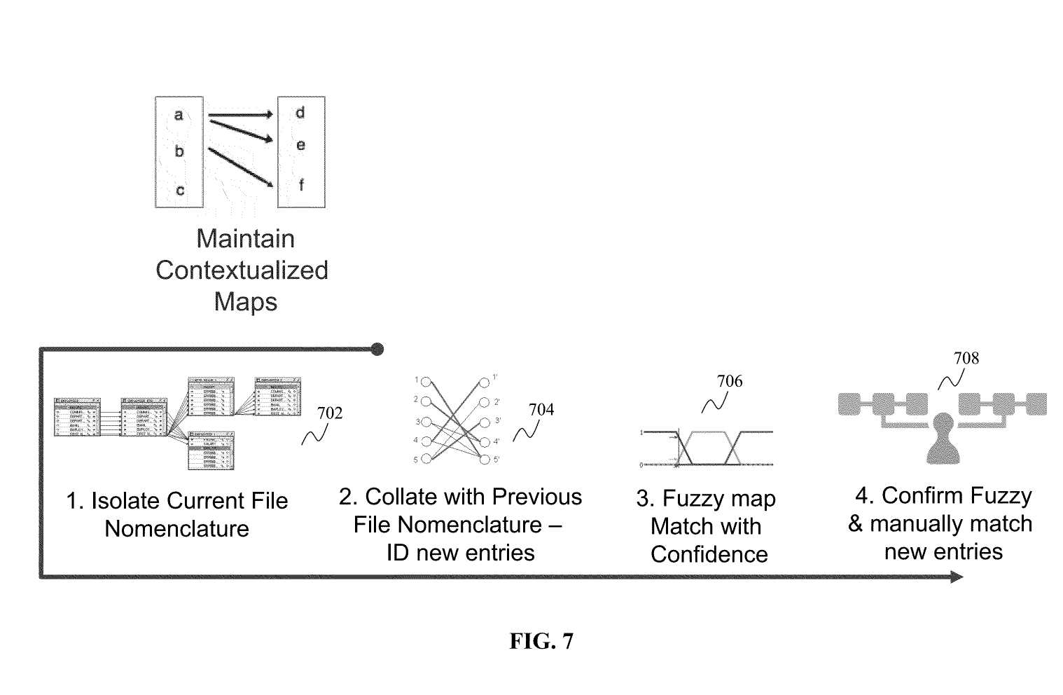

FIG. 7 illustrates an exemplary normalization model in an analytic engine, according to an embodiment of the present teaching. As shown in FIG. 7, the normalization model in this example comprises a contextualized mapping model. According to the contextualized mapping model, a plurality of functions may be performed, e.g. by the data normalizer 504. A first function 702 is to isolate current file nomenclature from the candidate prescription strings. A second function 704 is to collate the current file nomenclature with previous file nomenclature to identify new entries, i.e. the prescription strings that are not stored in the string database 336. A third function 706 is to generate a fuzzy map to characterize relations among the new entries and/or between the new entries and the existing prescription strings. Each relation may be associated with a confidence score representing a confidence about the relation. A fourth function 708 is to confirm fuzzy relations generated by the third function 706 and manually match the new entries based on the fuzzy map. The fourth function 708 may be performed together by the data normalizer 504 and a human. In this example, the data normalizer 504 may retrieve data from the string database 336 directly.

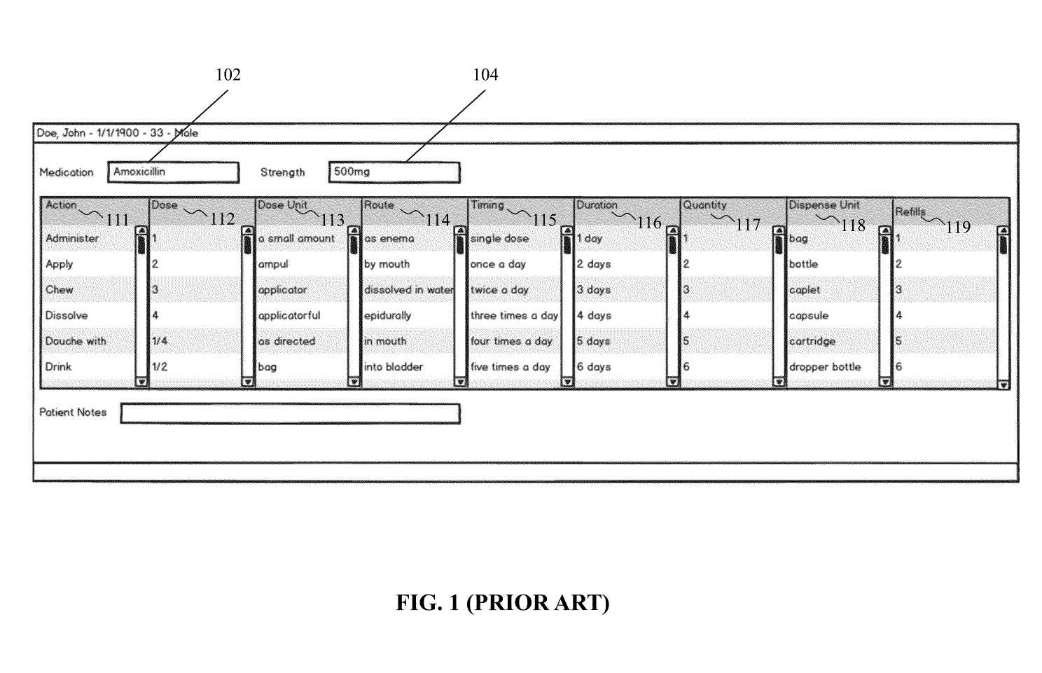

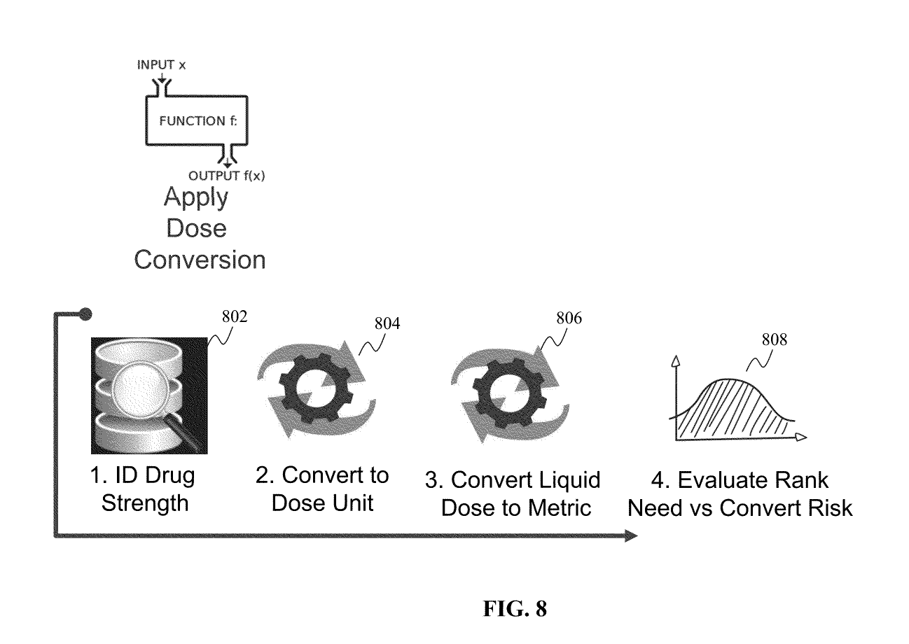

FIG. 8 illustrates another exemplary normalization model in an analytic engine, according to an embodiment of the present teaching. As shown in FIG. 8, the normalization model in this example comprises a dose conversion model. According to the dose conversion model, a plurality of functions may be performed, e.g. by the data normalizer 504. A first function 802 is to identify drug strength. For example, the drug strength is 500 mg for the prescription string shown in FIG. 2. A second function 804 is to convert the drug dose when entered relative to strength to a normalized dose unit. For example, if the normalized dose unit for the medication in FIG. 2 is “500 Mg” the second function 804 converts the drug dose in FIGS. 2 to 1 Capsule. In this manner, whether the drug dose is input as 500 mg or 1 Capsule, the prescription string recommending system 330 knows that this is the same drug dose.

A third function 806 is to convert all liquid dose units into Metric. For example, a drug in a liquid form is commonly dispensed in teaspoon. In that situation, the third function 806 will convert to a milliliter dose unit; so that the prescription string recommending system 330 knows that a first prescription string for a medication with the teaspoon dose has the same drug dose as a second prescription string for the same medication with the milliliter dose unit. This information may be used for ranking and/or recommending the prescription strings. In that situation, the normalization model in this example can be referred to as a liquid dose conversion model. A fourth function 808 is to evaluate rank need vs. the convert risk. There may be a tradeoff between the rank need and the convert risk. For example, when more and more prescription strings are converted to have a normalized dose unit, it is easier to rank the prescription strings but the risk of conversion error may increase as well. The fourth function 808 may evaluate this tradeoff and find a good tradeoff point for the dose conversion.

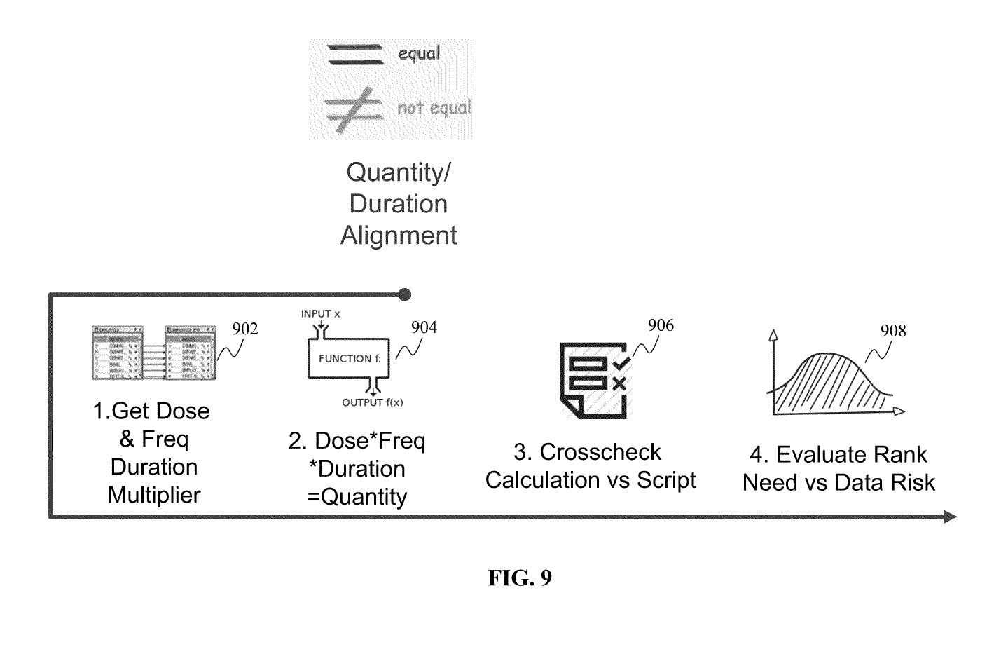

FIG. 9 illustrates yet another exemplary normalization model in an analytic engine, according to an embodiment of the present teaching. As shown in FIG. 9, the normalization model in this example comprises a quantity/duration alignment model. According to the quantity/duration alignment model, a plurality of functions may be performed, e.g. by the data normalizer 504. A first function 902 is to get dose, frequency, and duration information from each prescription string. A second function 904 is to calculate quantity for each prescription string by multiplying the dose, frequency and duration. A third function 906 is to crosscheck the calculation of quantity vs. a script that may include the information about the quantity. In this manner, different prescription strings can be aligned by the calculated quantity and/or the duration. A fourth function 908 is to evaluate rank need vs. data risk. There may be a tradeoff between the rank need and the data risk. For example, when more and more prescription strings are performed calculation of quantity following the second function 904, it is easier to rank the prescription strings but the risk of data calculation error may increase as well. The fourth function 908 may evaluate this tradeoff and find a good tradeoff point for the quantity/duration alignment.

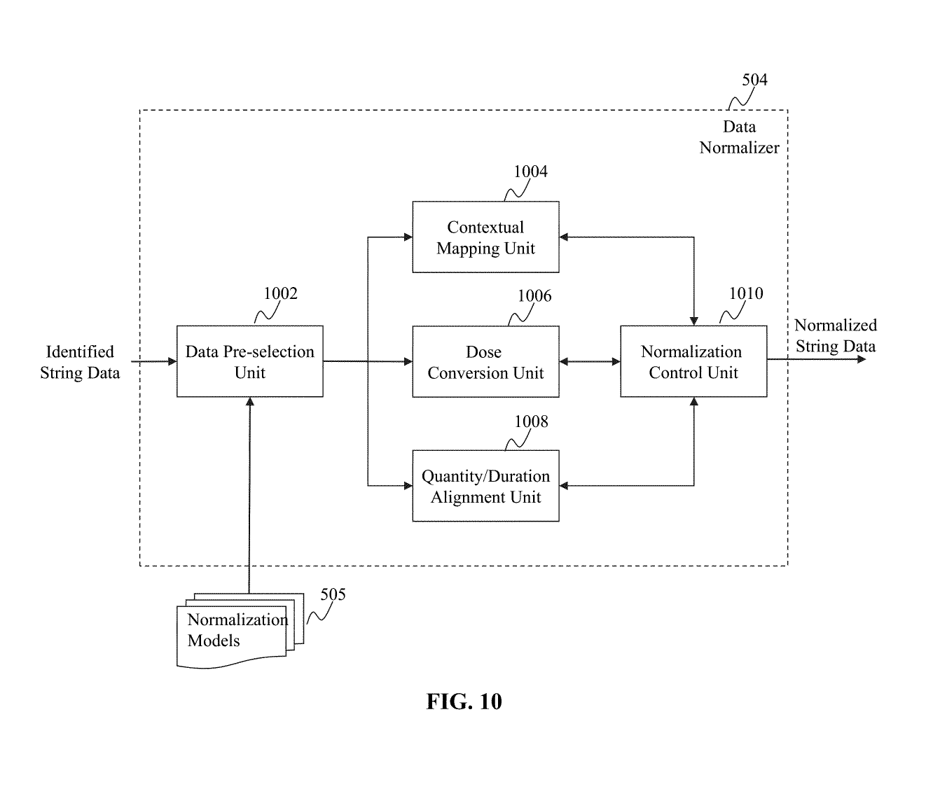

FIG. 10 illustrates an exemplary diagram of the data normalizer 504 in the analytic engine 334 (in FIG. 5), according to an embodiment of the present teaching. The data normalizer 504 in this example includes a data pre-selection unit 1002, a contextual mapping unit 1004, a dose conversion unit 1006, a quantity/duration alignment unit 1008, and a normalization control unit 1010.

The data pre-selection unit 1002 in this example receives identified prescription strings from the data analyzer 502 and pre-select data for different normalizations based on normalization models 505. The data pre-selection unit 1002 may select a normalization model and determine what data or which prescription strings should be normalized according to the selected normalization model. This may be performed for each normalization model in accordance with an embodiment. For each normalization model, the data pre-selection unit 1002 may send the pre-selected prescription strings data to one of the contextual mapping unit 1004, the dose conversion unit 1006, and the quantity/duration alignment unit 1008.

The contextual mapping unit 1004 in this example can perform the functions discussed before in FIG. 7. For example, the contextual mapping unit 1004 may identify new entries from the data and generate a fuzzy map to match the new entries. The dose conversion unit 1006 in this example can perform the functions discussed before in FIG. 8. For example, the dose conversion unit 1006 may identify drug strength from the data and convert the drug strength to a normalized dose unit. The quantity/duration alignment unit 1008 in this example can perform the functions discussed before in FIG. 9. For example, the quantity/duration alignment unit 1008 may obtain dose, frequency and duration information for each prescription string from the data and align the prescription strings with a calculated quantity based on the dose, frequency, and duration for each prescription string.

The normalization control unit 1010 in this example combines the normalized prescription strings data from the contextual mapping unit 1004, the dose conversion unit 1006, and the quantity/duration alignment unit 1008, and sends the combined data to the string de-duplicator 506 for de-duplication. In one embodiment, the normalization control unit 1010 may help the contextual mapping unit 1004, the dose conversion unit 1006, and the quantity/duration alignment unit 1008 to exchange data to each other. For example, the contextual mapping unit 1004 may utilize converted dose unit from the dose conversion unit 1006 to identify whether a prescription string is a new entry or not.

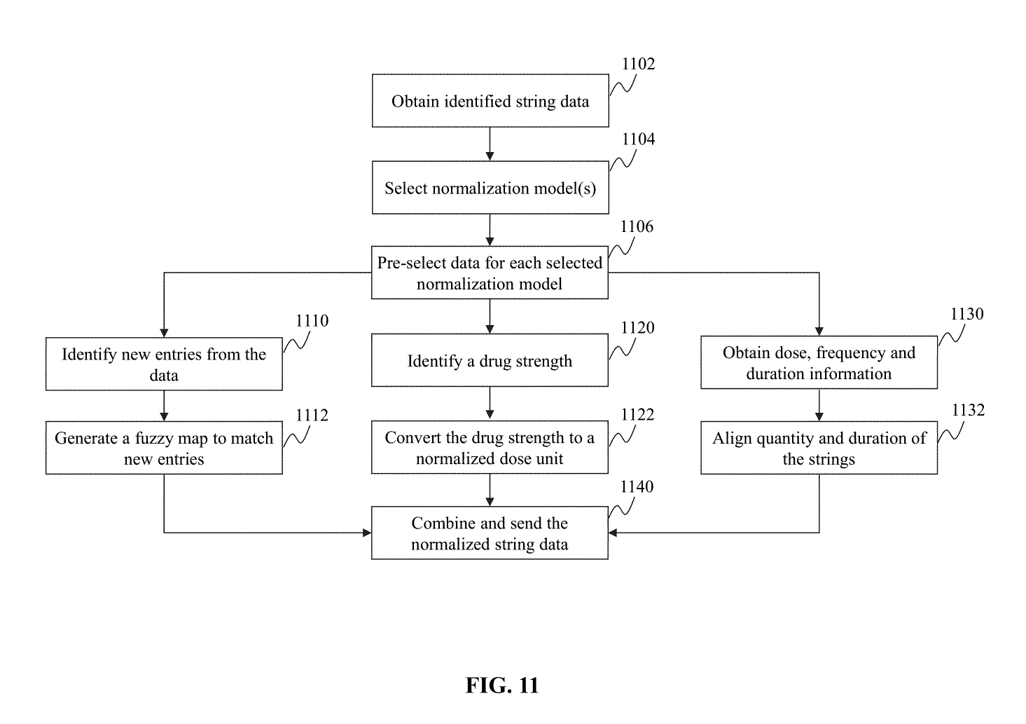

FIG. 11 is a flowchart of an exemplary process performed by a data normalizer, e.g. the data normalizer 504 in FIG. 10, according to an embodiment of the present teaching. Starting at 1102, identified prescription string data are obtained. At 1104, one or more normalization models are selected. At 1106, prescription string data are pre-selected for each of the selected normalization models. Depending on the selected normalization model, the process may go to 1110, 1120, and/or 1130 after 1106.

At 1110, new entries are identified from the prescription string data. At 1112, a fuzzy map is generated to match the new entries and the process goes to 1140. At 1120, drug strength is identified from the prescription string data. At 1122, the drug strength is converted to a normalized dose unit and the process goes to 1140. At 1130, information about dose, frequency, and duration is obtained. At 1132, quantity and duration of the prescription strings are utilized to align the prescription strings and the process goes to 1140. At 1140, the normalized prescription string data are combined and sent, e.g. to the string de-duplicator 506.

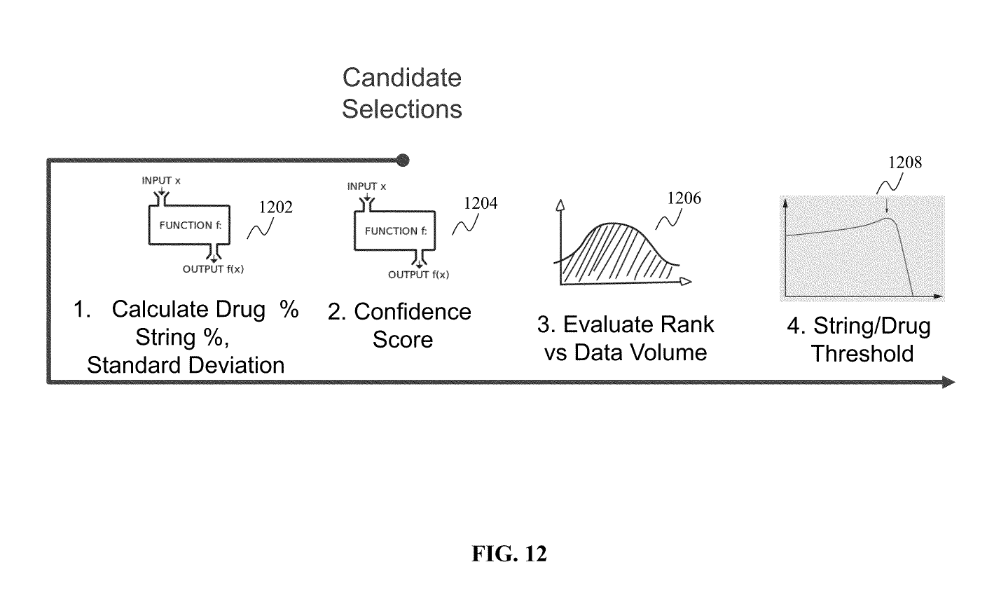

FIG. 12 illustrates an exemplary ranking model in an analytic engine, according to an embodiment of the present teaching. As shown in FIG. 12, the ranking model in this example is utilized to rank and select candidate prescription strings. According to the ranking model, a plurality of functions may be performed, e.g. by the ranking unit 510. A first function 1202 is to obtain or calculate drug and string related statistics, e.g. the percentage of drugs related to a given prescription string, the percentage of prescription strings related to a given drug, and standard deviation of number of prescription strings related to each drug, etc. A second function 1204 is to obtain a confidence score for each prescription string. In one embodiment, the confidence score can be identified from the de-duplicated string data. A third function 1206 is to evaluate rank vs. data volume. A rank for each prescription string can be determined based on its corresponding confidence score. But the candidate prescription strings are selected based on both their ranks and their frequency of which they are used by a user. The third function 1206 evaluates rank information of each prescription string vs. the data volume or frequency information associated with the prescription string. The fourth function 1208 is to determine a threshold based on the evaluation at the third function 1206. A candidate prescription string is selected as a prescription string to be qualified and stored in the string database 336, if the prescription string has a high enough ranking and an associated frequency higher than the threshold.

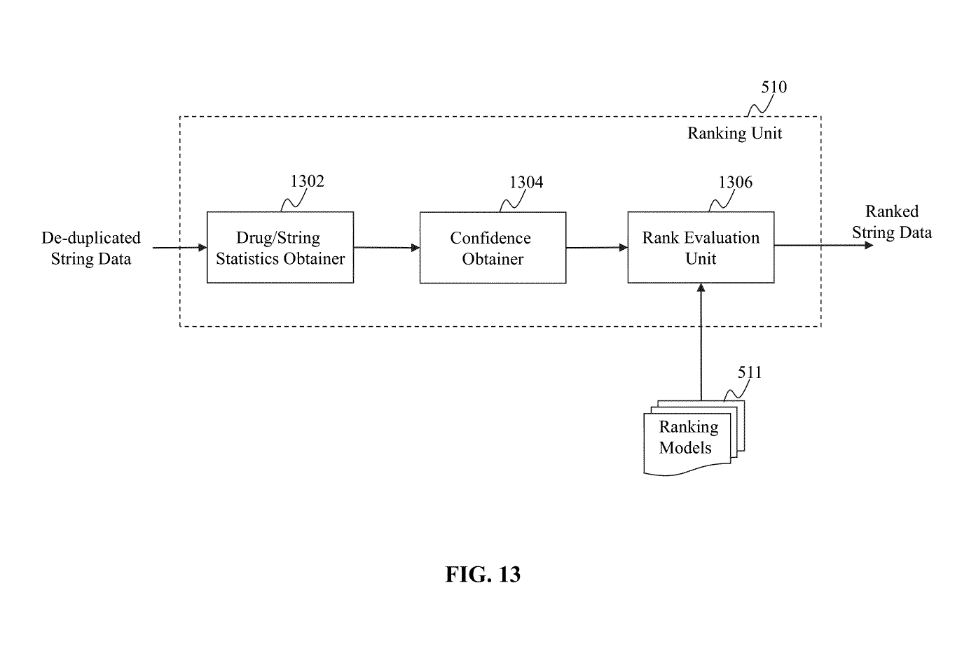

FIG. 13 illustrates an exemplary diagram of a ranking unit 510 in an analytic engine, e.g. the analytic engine 334 in FIG. 5, according to an embodiment of the present teaching. The ranking unit 510 in this example includes a drug/string statistics obtainer 1302, a confidence obtainer 1304, and a rank evaluation unit 1306.

The drug/string statistics obtainer 1302 in this example can perform the first function 1202 discussed before in FIG. 12. For example, the drug/string statistics obtainer 1302 may obtain drug and string related statistics. The confidence obtainer 1304 in this example can perform the second function 1204 discussed before in FIG. 12. For example, the confidence obtainer 1304 may obtain a confidence score for each drug and string. The rank evaluation unit 1306 in this example can perform the third function 1206 and the fourth function 1208 discussed before in FIG. 12. For example, the rank evaluation unit 1306 may evaluate rank vs. data volume to determine a string/drug threshold. The rank evaluation unit 1306 may also rank the prescription strings based on their confidence scores and a ranking model. The ranking model may specify the ranking be performed on the prescription strings passing the string/drug threshold, so that the rank evaluation unit 1306 sends the ranked prescription strings passing the threshold, e.g. to the quality control unit 512 for quality control.

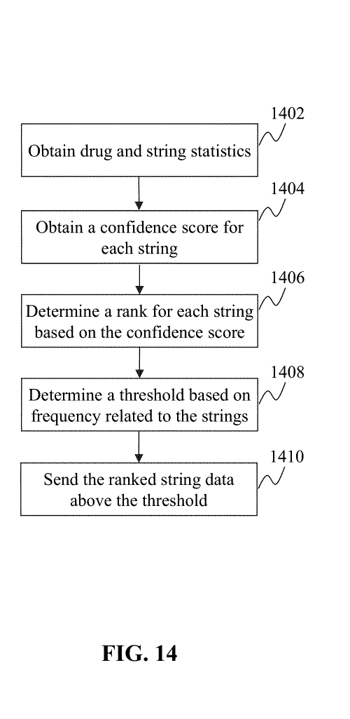

FIG. 14 is a flowchart of an exemplary process performed by a ranking unit, e.g. the ranking unit 510 in FIG. 13, according to an embodiment of the present teaching. Starting at 1402, drug and string statistics are obtained. At 1404, a confidence score is obtained for each prescription string. At 1406, a rank is determined for each prescription string based on the confidence score. At 1408, a threshold is determined based on frequency related to the prescription strings. At 1410, the ranked prescription strings that are above the threshold are sent, e.g. to the quality control unit 512 for quality control.

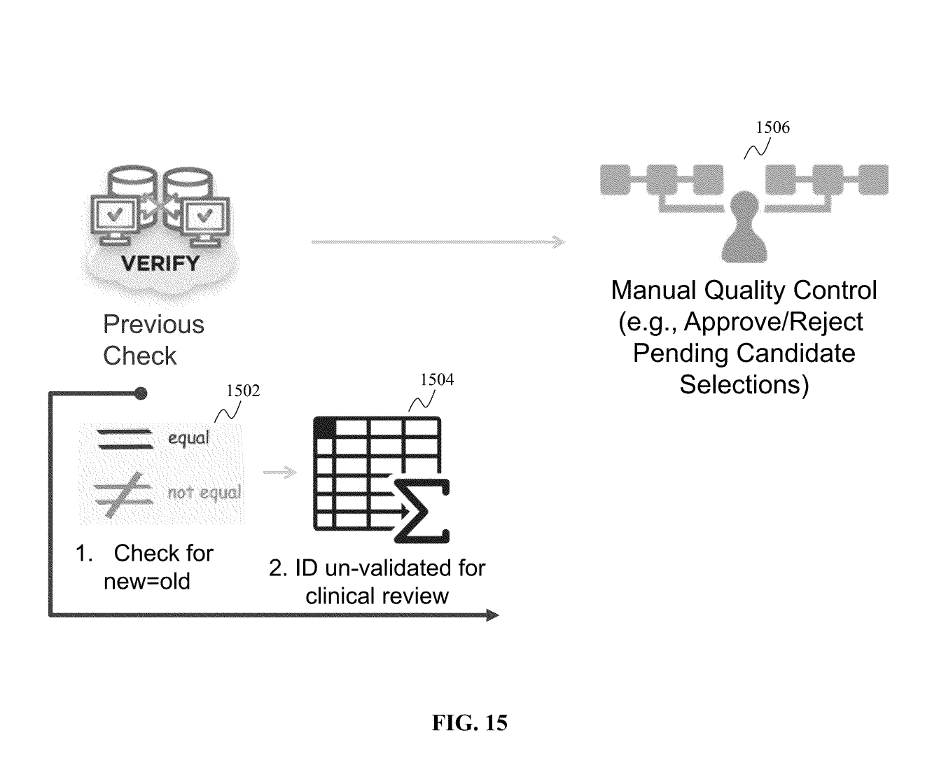

FIG. 15 illustrates functions that can be performed by a quality control unit in an analytic engine, e.g. the analytic engine 334 in FIG. 5, according to an embodiment of the present teaching. As shown in FIG. 15, a plurality of functions may be performed, e.g. by the quality control unit 512. A first function 1502 is to check whether a new prescription string is equal to an existing pre-qualified prescription string or not. A second function 1504 is to identify the new prescription strings that do not match any existing pre-qualified prescription strings, i.e. the un-validated prescription strings. A third function 1506 is to obtain human review of the un-validated prescription strings to determine a manual qualification for each un-validated prescription string. While the first function 1502 and the second function 1504 can be performed automatically by the quality control unit 512, the third function 1506 can be performed by the quality control unit 512 with an involvement or interaction from a human, e.g. the human manager 530 in FIG. 5.

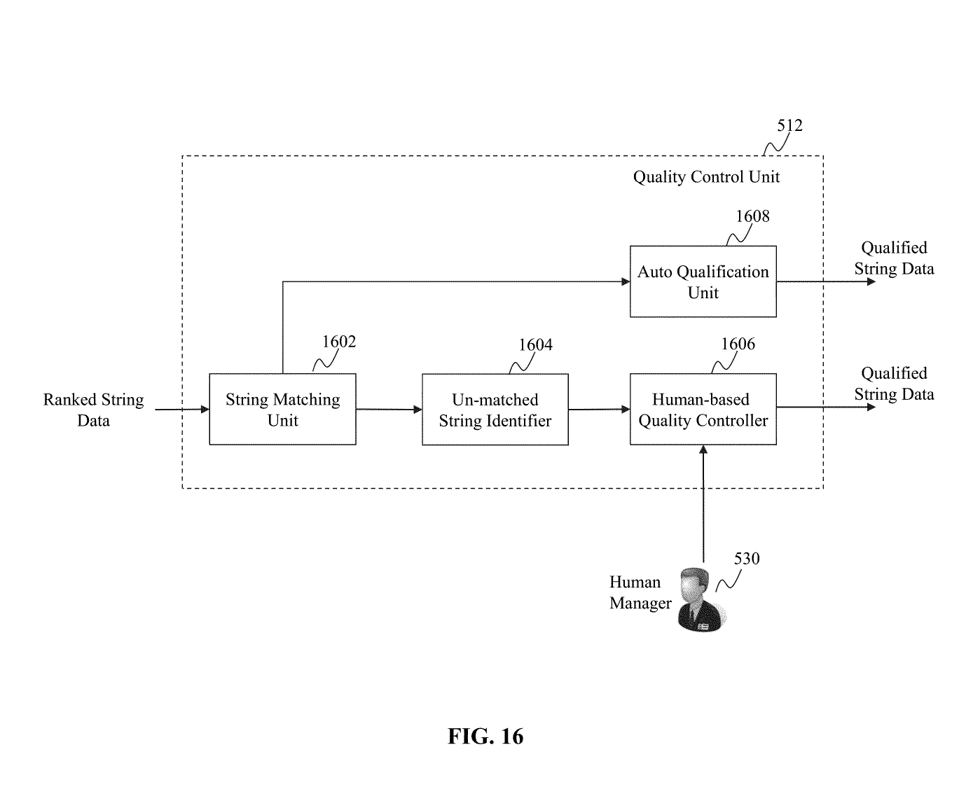

FIG. 16 illustrates an exemplary diagram of a quality control unit 512 in an analytic engine, e.g. the analytic engine 334 in FIG. 5, according to an embodiment of the present teaching. The quality control unit 512 in this example includes a string matching unit 1602, an un-matched string identifier 1604, a human-based quality controller 1606, and an auto qualification unit 1608.

The string matching unit 1602 in this example can perform the first function 1502 discussed before in FIG. 15. For example, the string matching unit 1602 may compare each ranked prescription string with pre-qualified prescription strings and sends each ranked prescription string to the un-matched string identifier 1604 or the auto qualification unit 1608 based on the comparison result. If a match is found for the prescription string based on the comparison result, the prescription string is sent to the auto qualification unit 1608 for auto qualification. Otherwise, if no match is found based on the comparison result, the prescription string is sent to the un-matched string identifier 1604. The un-matched string identifier 1604 in this example can perform the second function 1504 discussed before in FIG. 15. For example, the un-matched string identifier 1604 may identify the un-matched prescription strings, i.e. un-validated prescription strings, and may send them to the human-based quality controller 1606 for human review. The human-based quality controller 1606 in this example can perform the third function 1506 discussed before in FIG. 15. For example, the human-based quality controller 1606 may obtain human review from the human manager 530 regarding each un-matched prescription string and qualify some un-matched prescription strings based on the human review. The auto qualification unit 1608 may automatically qualify prescription strings that are matched with pre-qualified prescription strings. The qualified string data from the auto qualification unit 1608 and the human-based quality controller 1606 are sent, e.g. to the re-contextualizing unit 514.

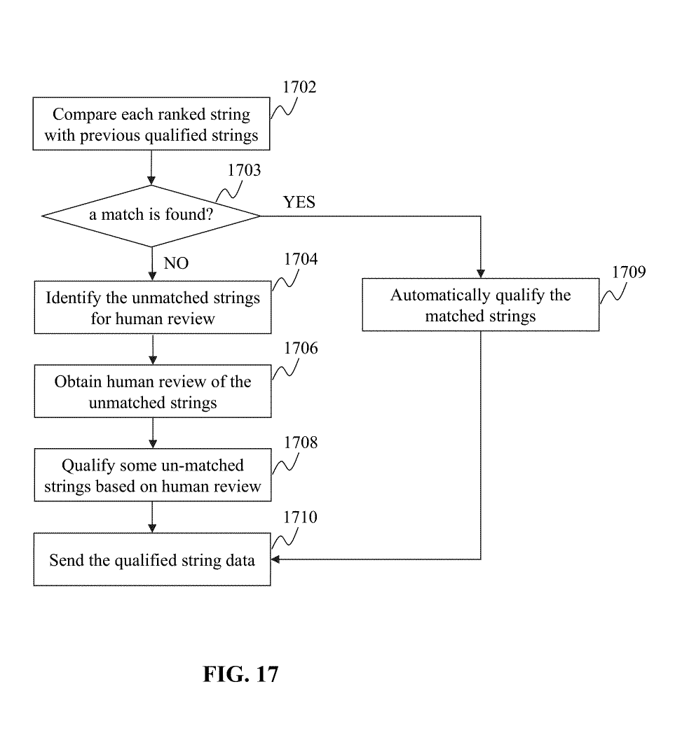

FIG. 17 is a flowchart of an exemplary process performed by a quality control unit, e.g. the quality control unit 512 in FIG. 16, according to an embodiment of the present teaching. Starting at 1702, each ranked prescription string is compared with previously qualified prescription strings. At 1703, it is determined whether a match is found for the prescription string based on the comparison result at 1702. If so, the process goes to 1709, where the matched prescription strings are automatically qualified and the process proceeds to 1710. Otherwise, if no match is found for the prescription string based on the comparison result at 1702, the process goes to 1704, where the un-matched prescription strings are identified for human review. At 1706, human review is obtained for each un-matched prescription string. At 1708, one or more un-matched prescription strings are qualified based on the human review. It can be understood that in one example all of the un-matched prescription strings are qualified based on the human review while in another example no un-matched prescription string is qualified based on the human review. At 1710, the qualified prescription strings are sent, e.g. to the re-contextualizing unit 514 for re-contextualization.

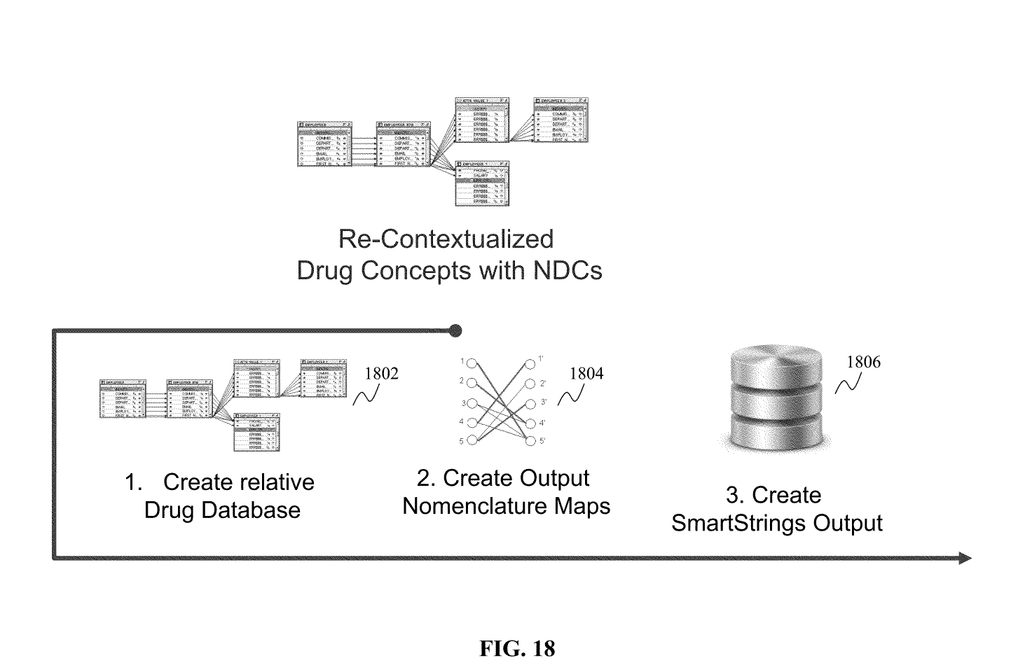

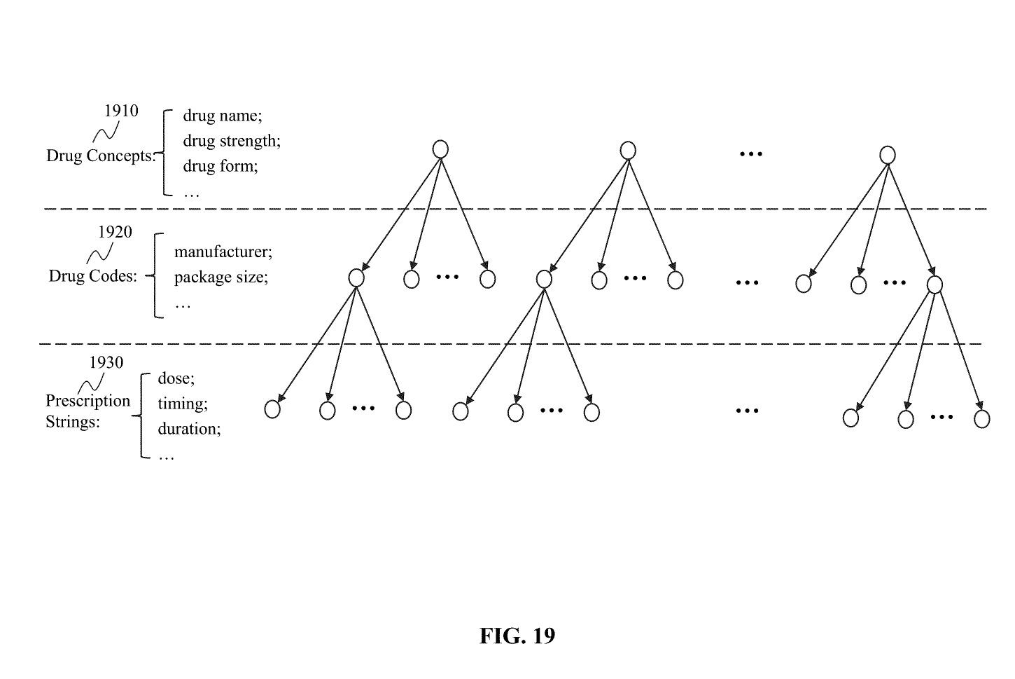

FIG. 18 illustrates functions that can be performed by a re-contextualizing unit in an analytic engine, e.g. the analytic engine 334 in FIG. 5, according to an embodiment of the present teaching. As shown in FIG. 18, a plurality of functions may be performed, e.g. by the re-contextualizing unit 514. A first function 1802 is to create a relative drug database. The database comprises drug data in a hierarchical structure. FIG. 19 illustrates an exemplary hierarchical structure for a drug from a drug concept to a prescription string, according to an embodiment of the present teaching. Each drug may have a plurality of drug concepts 1910. Each drug concept can specify some information related to the drug including but not limited to the drug name (e.g. Tylenol, Amoxicillin), drug strength (e.g. 500 mg, 300 mg), and drug form (e.g. tablet, capsule). Thus, a drug can be produced with different drug concepts, in accordance with different drug names, different drug strengths and/or different drug forms.

Each drug concept can be associated with a plurality of drug codes 1920. Each drug code can specify additional information related to the drug concept including but not limited to the manufacturer (e.g. CVS, Walgreen) and package size (e.g. 50 tablets, 200 tablets). Thus, a drug or drug concept can be sold in the market with different drug codes, in accordance with different manufacturers and/or different package sizes. In practice, the drug code can be the NDC.

Each drug code can be associated with a plurality of prescription strings 1930. Each prescription string can specify additional information related to the drug code including but not limited to the dose (e.g. 1, 2), timing (e.g. once a day, twice a day), and duration (e.g. 5 days, 10 days). Thus, a drug with the same drug concept and the same drug code can be prescribed by a physician with different prescription strings, in accordance with different doses, different timings and/or different durations. In one embodiment, a prescription string is determined based on an associated drug code. For example, a physician may prescribe for a patient to take a drug for once a day if the drug is “sustained release” manufactured by CVS, while prescribing for the same patient to take the same drug twice a day if the drug is not sustained release manufactured by Walgreen. Thus, a complete prescription string may include information in each of the three levels: drug concept, drug code, and prescription string.

Back to FIG. 18, the candidate prescription strings were previously processed on the drug concept level. Thus, before the re-contextualization, the prescription strings were ranked and/or qualified without taking into consideration of the information about the manufacturers and package sizes. By creating relative drug database and re-contextualizing the prescription strings, each prescription string is associated with one or more drug codes, in addition to the associated drug concepts. In one embodiment, after the prescription strings are ranked on the drug level and drug concept level, the prescription strings can be further ranked and qualified on the drug code level (e.g. by different NDC codes) and/or on the prescription string level. In this manner, each drug concept is re-contextualized with different drug codes.

A second function 1804 in FIG. 18 is to generate a nomenclature map with the qualified prescription strings. A third function 1806 in FIG. 18 is to output the re-contextualized prescription strings to the string database 336.

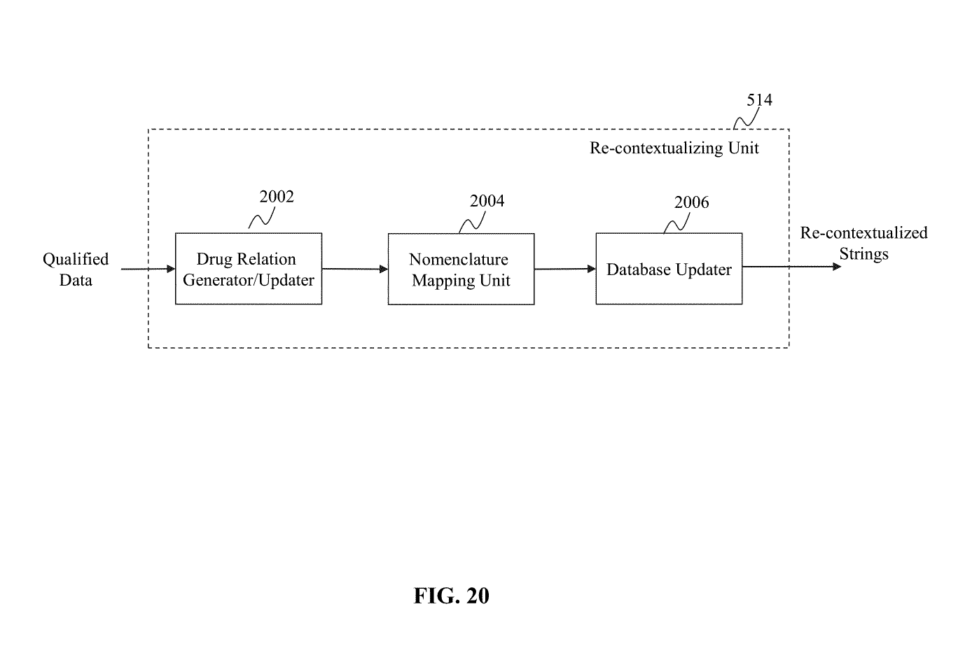

FIG. 20 illustrates an exemplary diagram of a re-contextualizing unit 514 in an analytic engine, e.g. the analytic engine 334 in FIG. 5, according to an embodiment of the present teaching. The re-contextualizing unit 514 in this example includes a drug relation generator/updater 2002, a nomenclature mapping unit 2004, and a database updater 2006.

The drug relation generator/updater 2002 in this example can perform the first function 1802 discussed before in FIG. 18. For example, the drug relation generator/updater 2002 may create or update drug/string relations by re-contextualizing each drug concept with one or more drug codes. The nomenclature mapping unit 2004 in this example can perform the second function 1804 discussed before in FIG. 18. For example, the nomenclature mapping unit 2004 may generate a nomenclature map with the qualified prescription strings. The database updater 2006 in this example can perform the third function 1806 discussed before in FIG. 18. For example, the database updater 2006 may update the string database 336 by saving the re-contextualized strings into the string database 336.

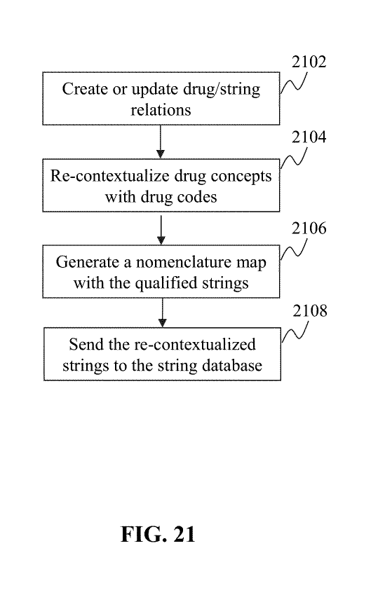

FIG. 21 is a flowchart of an exemplary process performed by a re-contextualizing unit, e.g. the re-contextualizing unit 514 in FIG. 20, according to an embodiment of the present teaching. Starting at 2102, drug/string relations are created or updated. At 2104, drug concepts are re-contextualized with drug codes, e.g. NDC codes. At 2106, a nomenclature map is generated with the qualified strings. At 2108, the re-contextualized prescription strings are sent to the string database 336.

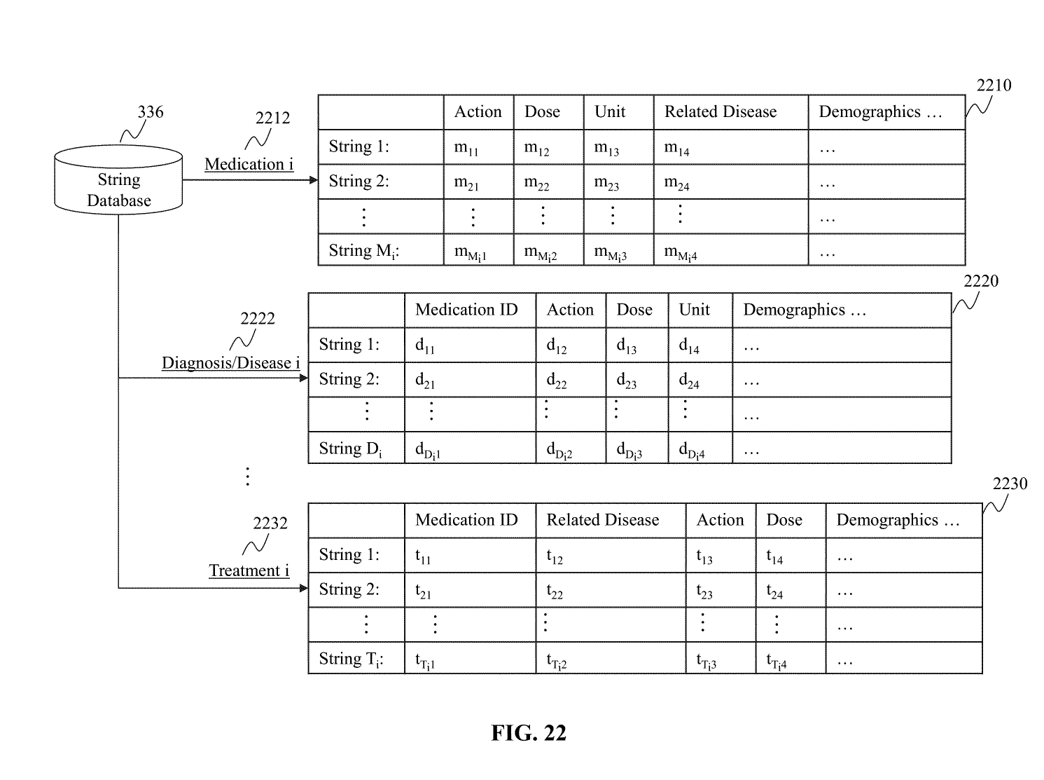

FIG. 22 illustrates different methods for retrieving prescription strings, according to various embodiments of the present teaching. As shown in FIG. 22, the prescription strings in the string database 336 can be retrieved by a medication. For example, based on medication i 2212, Mᵢ prescription strings 2210 associated with the medication i are retrieved. Each of the Mᵢ prescription strings 2210 may include different fields/attributes including but not limited to action, dose, unit, related disease, and demographics. In one embodiment, the demographics include information like age and gender related to patients regarding whom the prescription strings were ordered. In another embodiment, the demographics do not include personal information of these patients.

As shown in FIG. 22, the prescription strings in the string database 336 can also be retrieved by a diagnosis, a disease, and/or a treatment. For example, based on a diagnosis/disease i 2222, Dᵢ prescription strings 2220 associated with the diagnosis/disease i are retrieved. Each of the Dᵢ prescription strings 2220 may include different fields including but not limited to medication ID, action, dose, unit, and demographics. In another example, based on a treatment i 2232, Tᵢ prescription strings 2230 associated with the treatment i are retrieved. Each of the Tᵢ prescription strings 2230 may include different fields/attributes including but not limited to medication ID, action, dose, unit, related disease, and demographics.

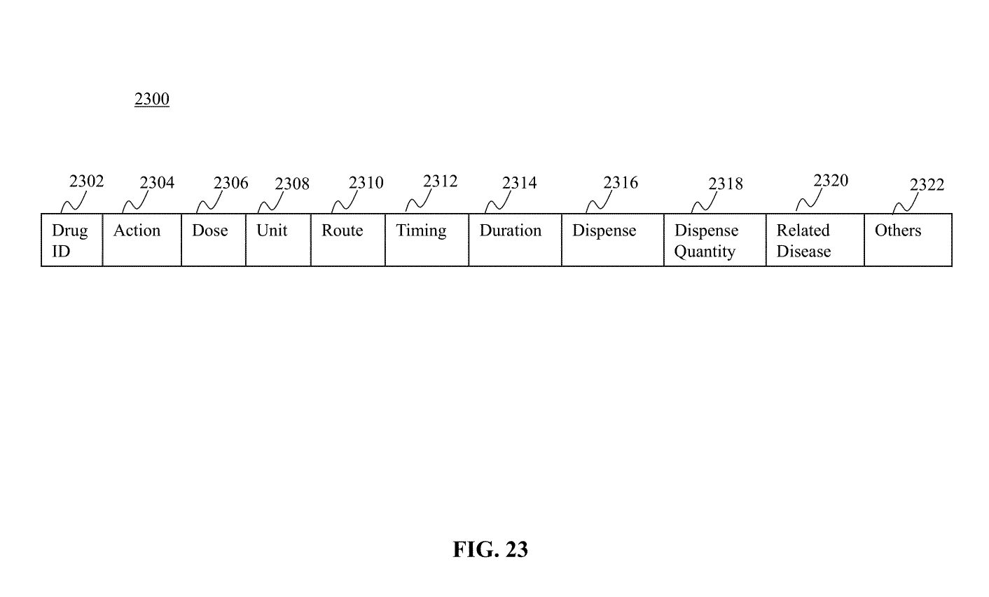

FIG. 23 illustrates an exemplary prescription string 2300, according to an embodiment of the present teaching. As shown in FIG. 23, the prescription string 2300 includes eleven fields: drug ID 2302, action 2304, dose 2306, unit 2308, route 2310, timing 2312, duration 2314, dispense 2316, dispense quantity 2318, related disease 2320, and others 2322. Other exemplary prescription strings can be seen in FIG. 2.

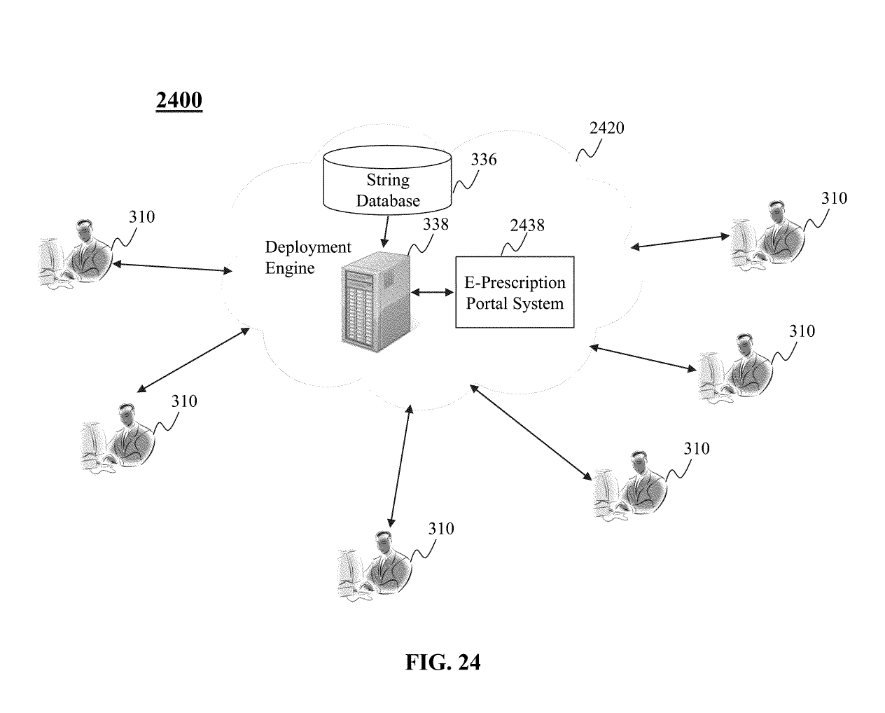

FIG. 24 illustrates a cloud based network environment 2400 for a deployment engine 338, according to an embodiment of the present teaching. The cloud based network environment 2400 includes a cloud 2420 and a plurality of users 310. The cloud 2420 includes the string database 336, the deployment engine 338, and an e-prescription portal system 2438. The e-prescription portal system 2438 may serve as a portal-based interface between the deployment engine 338 and the users 310 connecting to the cloud 2420. In embodiment, the e-prescription portal system 2438 is located outside the deployment engine 338 as shown in FIG. 24. In another embodiment, the e-prescription portal system 2438 is located inside the deployment engine 338. In this cloud based network environment 2400, each user 310 may log in to the e-prescription portal system 2438 to request prescription strings from the deployment engine 338.

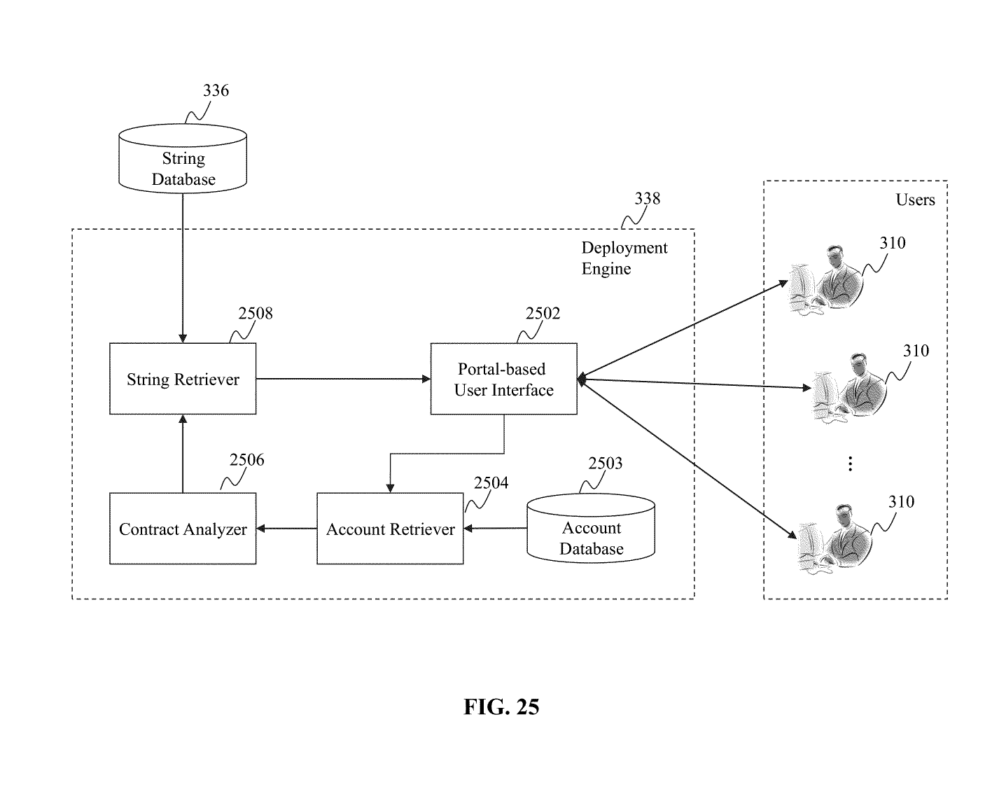

FIG. 25 illustrates an exemplary diagram of a deployment engine 338, e.g. the deployment engine 338 in FIG. 24, according to an embodiment of the present teaching. The deployment engine 338 in this example includes a portal-based user interface 2502, an account retriever 2504, an account database 2503, a contract analyzer 2506, and a string retriever 2508.

The portal-based user interface 2502 in this example receives log-in information and/or a request for prescription strings from one of the users 310. As discussed before, the users 310 may include hospitals, clinics, and/or physicians. The account retriever 2504 in this example retrieves an account from the account database 2503 based on the log-in information received by the portal-based user interface 2502. The account retriever 2504 may send information related to the account to the contract analyzer 2506. The contract analyzer 2506 in this example analyzes contract information associated with the account. For example, a contract associated with the account may specify whether the user associated with the account has authorization to access the prescription strings in the string database 336, and if so, under what conditions.

The contract analyzer 2506 may determine whether the account information meets the required conditions to obtain the requested prescription strings based on the contract analysis. If so, the string retriever 2508 may retrieve the requested prescription strings from the string database 336 and send the retrieved prescription strings to the user via the portal-based user interface 2502. Otherwise, the string retriever 2508 may send an error message to the user to indicate an error.

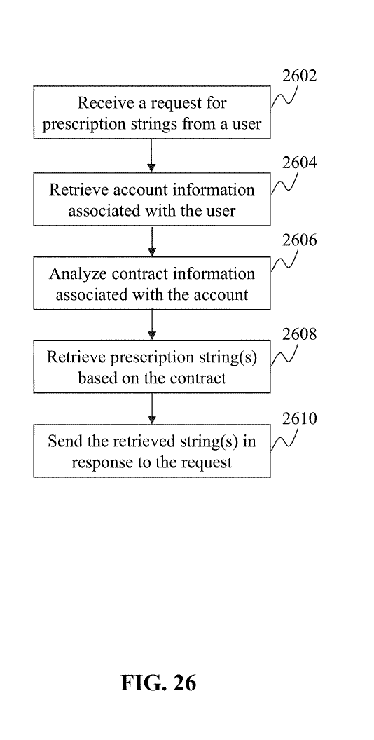

FIG. 26 is a flowchart of an exemplary process performed by a deployment engine, e.g. the deployment engine 338 in FIG. 25, according to an embodiment of the present teaching. Starting at 2602, a request for prescription strings is received from a user. At 2604, account information associated with the user is retrieved. At 2606, contract information associated with the account is analyzed. At 2608, one or more prescription strings are retrieved based on the contract. At 2610, the one or more prescription strings are sent in response to the request.

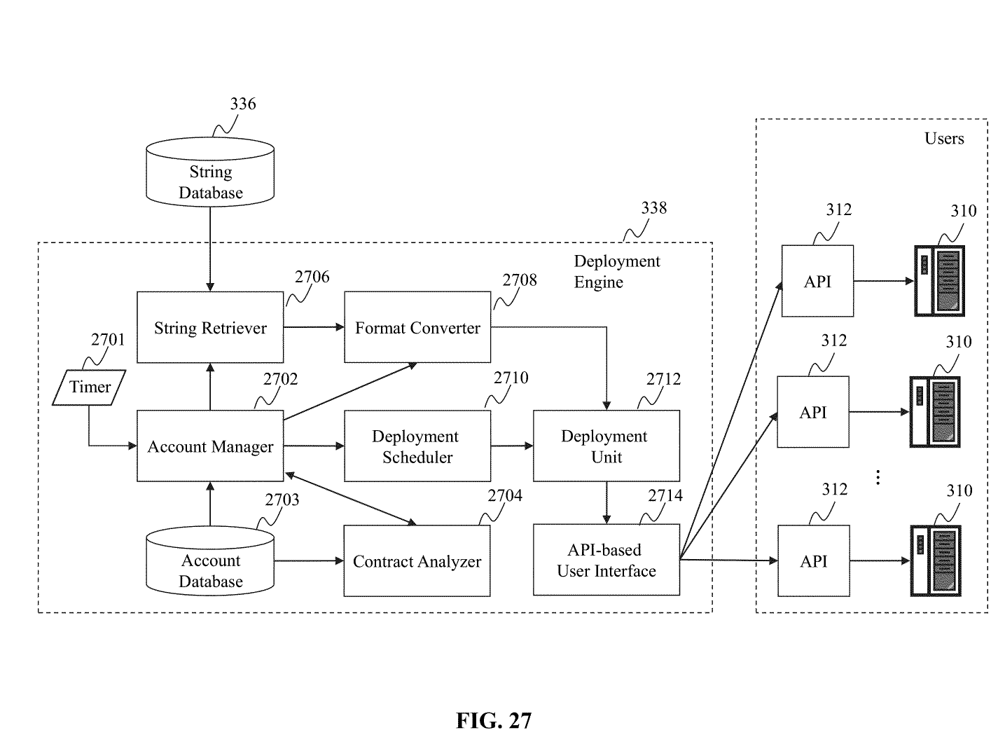

FIG. 27 illustrates another exemplary diagram of a deployment engine 338, e.g. the deployment engine 338 in FIG. 3, according to another embodiment of the present teaching. The deployment engine 338 in this example includes a timer 2701, an account manager 2702, an account database 2703, a contract analyzer 2704, a string retriever 2706, a format converter 2708, a deployment scheduler 2710, a deployment unit 2712, and an API-based user interface 2714.

The account manager 2702 in this example can determine whether it is time to manage an account for deploying prescription strings to a user 310 based on information from the timer 2701. If so, the account manager 2702 may retrieve account information related to the user from the account database 2703 and trigger the contract analyzer 2704 to analyze a contract associated with the account. The contract analyzer 2704 in this example analyzes contract information associated with the account to determine whether the user associated with the account has met the conditions required to obtain the prescription strings from the string database 336. If so, the account manager 2702 sends information to the string retriever 2706, the format converter 2708 and the deployment scheduler 2710.

The string retriever 2706 in this example retrieves prescription strings from the string database 336 based on information received from the account manager 2702 and sends the prescription strings to the format converter 2708. The format converter 2708 receives information from the account manager 2702 to determine a format that can be compatible with application programming interface (API) 312 of the user 310. The format converter 2708 then converts the prescription strings from the string retriever 2706 to the format. The deployment scheduler 2710 in this example determines a schedule for deploying the prescription strings based on the information from the account manager 2702. For example, when deployment for multiple accounts is due within a same time period, deployment for an account associated with a higher priority based on contract information may be scheduled earlier than deployment for another account associated with a lower priority based on contract information.

The deployment unit 2712 in this example receives schedule information for each account and retrieved prescription strings for each account with corresponding formats. The deployment unit 2712 then sends the prescription strings to the users according to the schedule information via the API-based user interface 2714.

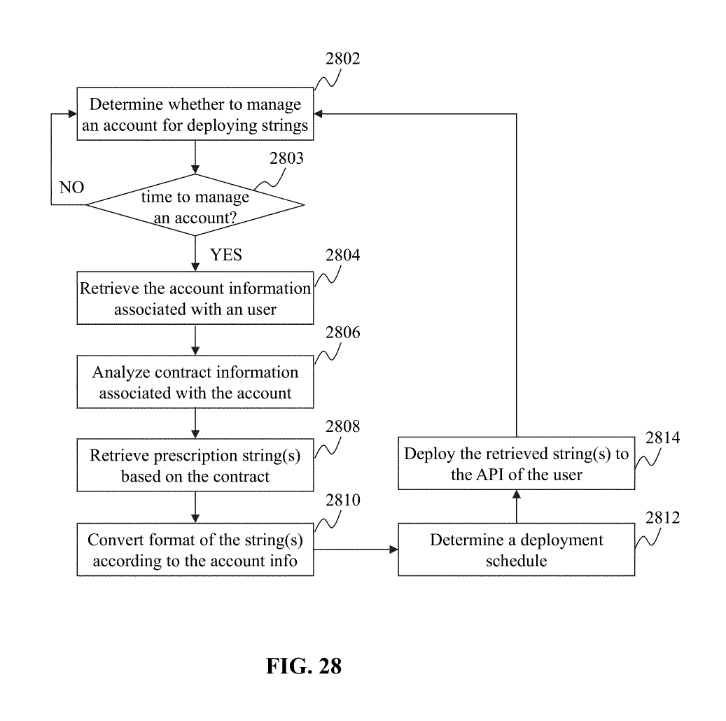

FIG. 28 is a flowchart of another exemplary process performed by a deployment engine, e.g. the deployment engine 338 in FIG. 27, according to another embodiment of the present teaching. Starting at 2802, it is determined whether it is time to manage an account for deploying strings to a user. At 2803, the result of determination of 2802 is checked. If it is not yet time to manage an account, the process goes back to 2802 to continue monitoring the time and account information. Otherwise, if it is time to manage an account associated with a user, the process goes to 2804, where the account information associated with the user is retrieved. At 2806, contract information associated with the account is analyzed. At 2808, one or more prescription strings are retrieved based on the contract.

At 2810, the one or more prescription strings are converted to a format that is compatible with API of the user, according to the account information. At 2812, a deployment schedule is determined based on the account information and other accounts having deployment tasks in the same time period. At 2814, the retrieved prescription strings are deployed to the API of the user, and the process goes back to 2802 to manage other accounts.

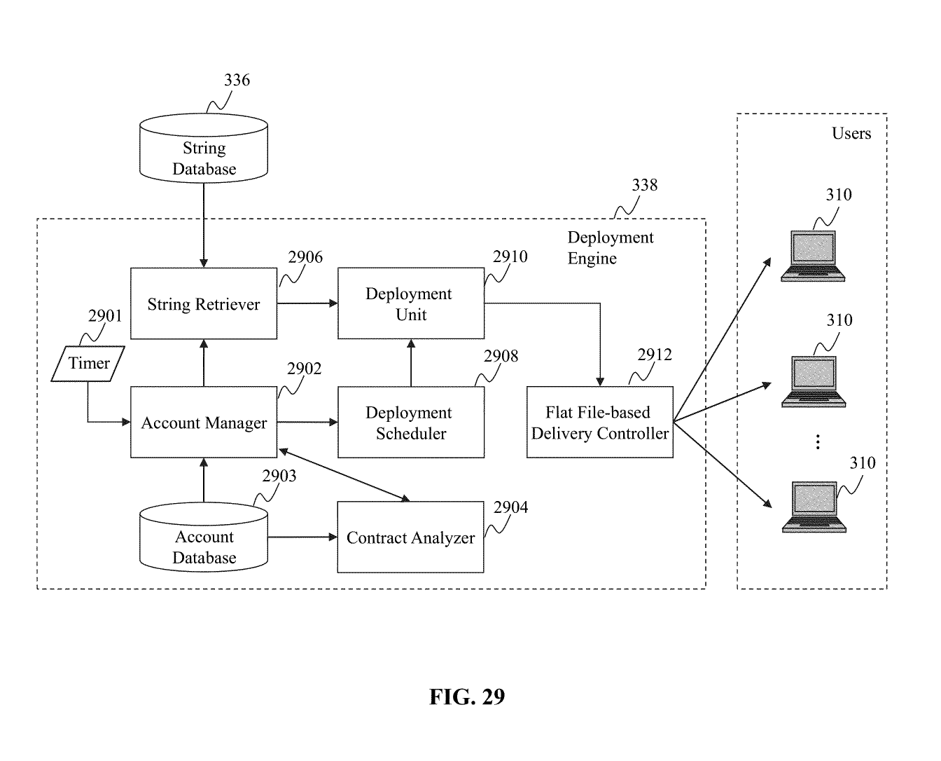

FIG. 29 illustrates yet another exemplary diagram of a deployment engine, e.g. the deployment engine 338 in FIG. 3, according to another embodiment of the present teaching. The deployment engine 338 in this example includes a timer 2901, an account manager 2902, an account database 2903, a contract analyzer 2904, a string retriever 2906, a deployment scheduler 2908, a deployment unit 2910, and a flat file-based delivery controller 2912.

The account manager 2902 in this example can determine whether it is time to manage an account for deploying prescription strings to a user 310 based on information from the timer 2901. If so, the account manager 2902 may retrieve account information related to the user from the account database 2903 and trigger the contract analyzer 2904 to analyze a contract associated with the account. The contract analyzer 2904 in this example analyzes contract information associated with the account to determine whether the user associated with the account has met the conditions required to obtain the prescription strings from the string database 336. If so, the account manager 2902 sends information to the string retriever 2906 and the format converter 2708.

The string retriever 2906 in this example retrieves prescription strings from the string database 336 based on information received from the account manager 2902 and sends the prescription strings to the deployment unit 2910. The deployment scheduler 2908 in this example determines a schedule for deploying or delivering the prescription strings based on the information from the account manager 2902. For example, when delivery for multiple accounts is due within a same time period, delivery for an account associated with a higher priority based on contract information may be scheduled earlier than delivery for another account associated with a lower priority based on contract information.

The deployment unit 2910 in this example receives schedule information for each account and retrieved prescription strings for each account. The deployment unit 2910 generates a flat file for each account based on the retrieved prescription strings, where the flat file is compatible with any user 310 so that the user 310 can obtain the data in the flat file and convert to any format if the user 310 wants. The flat file-based delivery controller 2912 in this example controls delivery of the flat files to the users 310. For example, a flat file can be delivered via an email, via an electronic message, via an online platform, or by a person.

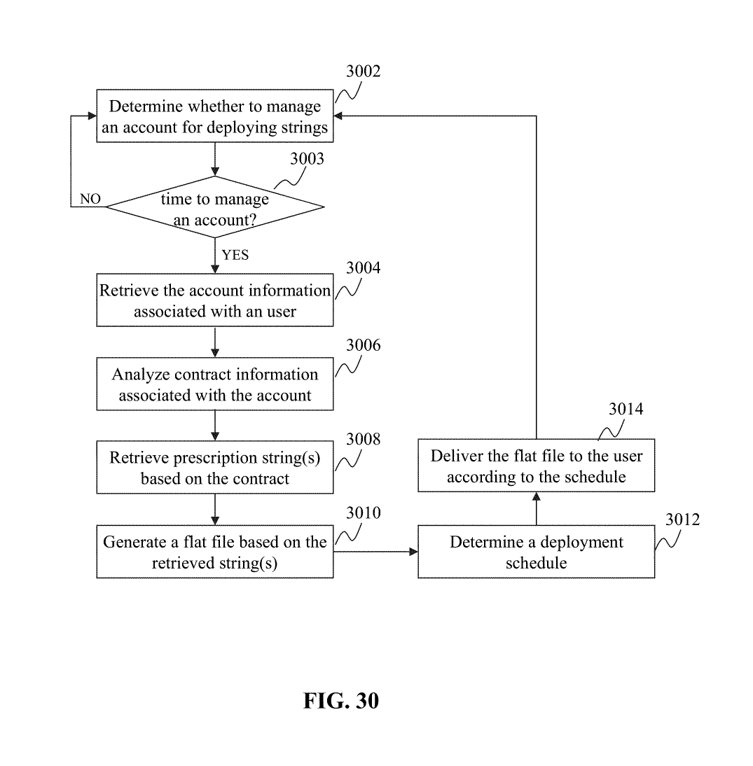

FIG. 30 is a flowchart of yet another exemplary process performed by a deployment engine, e.g. the deployment engine 338 in FIG. 29, according to another embodiment of the present teaching. Starting at 3002, it is determined whether it is time to manage an account for deploying strings to a user. At 3003, the result of determination of 3002 is checked. If it is not yet time to manage an account, the process goes back to 3002 to continue monitoring the time and account information. Otherwise, if it is time to manage an account associated with a user, the process goes to 3004, where the account information associated with the user is retrieved. At 3006, contract information associated with the account is analyzed. At 3008, one or more prescription strings are retrieved based on the contract.

At 3010, a flat file is generated based on the one or more prescription strings. At 3012, a deployment schedule is determined based on the account information and other accounts having deployment tasks in the same time period. At 3014, the flat file is delivered to the user according to the schedule, and the process goes back to 3002 to manage other accounts.

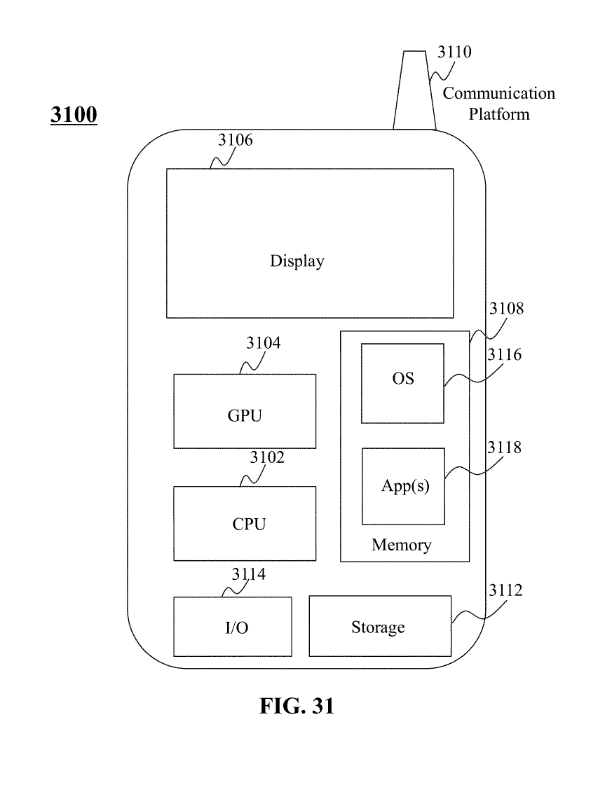

FIG. 31 depicts a general mobile device architecture on which the present teaching can be implemented. In this example, a device of the user 310 used for receiving and presenting recommended prescription string may be a mobile device 3100, including but is not limited to, a smart phone, a tablet, a music player, a handled gaming console, a GPS receiver. The mobile device 3100 in this example includes one or more central processing units (CPUs) 3102, one or more graphic processing units (GPUs) 3104, a display 3106, a memory 3108, a communication platform 3110, such as a wireless communication module, storage 3112, and one or more input/output (I/O) devices 3114. Any other suitable component, such as but not limited to a system bus or a controller (not shown), may also be included in the mobile device 3100. As shown in FIG. 31, a mobile operating system 3116, e.g., iOS, Android, Windows Phone, etc., and one or more applications 3118 may be loaded into the memory 3108 from the storage 3112 in order to be executed by the CPU 3102. The applications 3118 may include a web browser or any other suitable mobile apps used for electronic prescriptions. Execution of the applications 3118 may cause the mobile device 3100 to perform some processing as described b in the present teaching. For example, user inputs may be received via the I/O devices 3114 and sent to the prescription string recommending system 330 via the communication platform 3110. Presentation of the recommended prescription strings to the user may be made by the GPU 3104 in conjunction with the display 3106.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

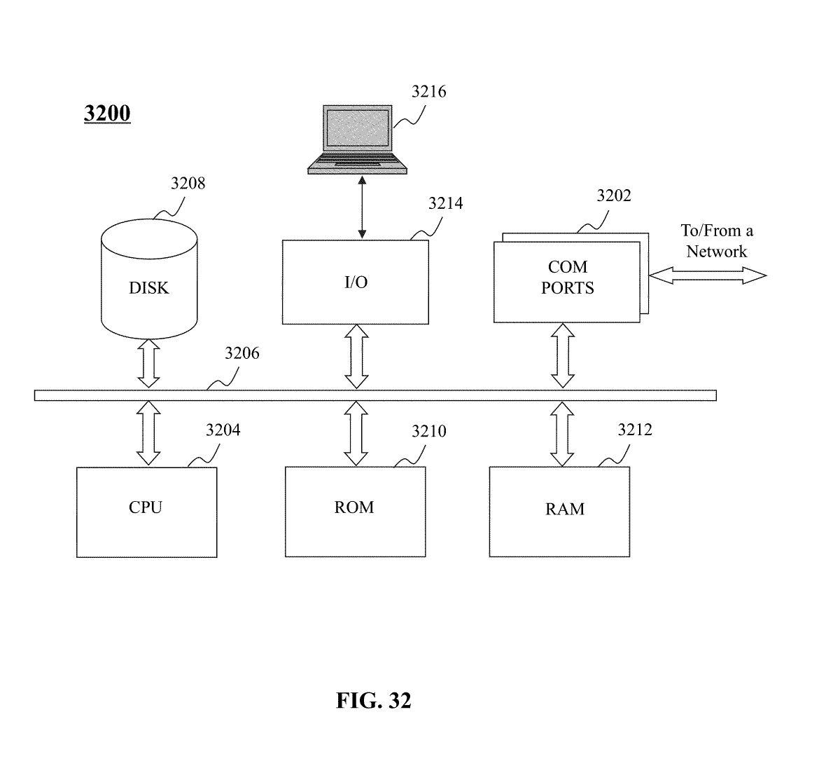

FIG. 32 depicts a general computer architecture on which the present teaching can be implemented and has a functional block diagram illustration of a computer hardware platform that includes user interface elements. The computer may be a general-purpose computer or a special purpose computer. This computer 3200 can be used to implement any components of the prescription string recommendation architecture as described herein. Different components of the system, e.g., as depicted in FIG. 3, can all be implemented on one or more computers such as computer 3200, via its hardware, software program, firmware, or a combination thereof. Although only one such computer is shown, for convenience, the computer functions relating to prescription string generation and recommendation may be implemented in a distributed fashion on a number of similar platforms, to distribute the processing load.

The computer 3200, for example, includes COM ports 3202 connected to and from a network connected thereto to facilitate data communications. The computer 3200 also includes a CPU 3204, in the form of one or more processors, for executing program instructions. The exemplary computer platform includes an internal communication bus 3206, program storage and data storage of different forms, e.g., disk 3208, read only memory (ROM) 3210, or random access memory (RAM) 3212, for various data files to be processed and/or communicated by the computer, as well as possibly program instructions to be executed by the CPU 3204. The computer 3200 also includes an I/O component 3214, supporting input/output flows between the computer and other components therein such as user interface elements 3216. The computer 3200 may also receive programming and data via network communications.

Hence, aspects of the method of prescription string generation and recommendation, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on at least one computing device each of which has at least one processor, storage, and a communication platform connected to a network for generating prescription strings, the method comprising:
obtaining data related to a medication drug;
identifying one or more candidate prescription strings from the obtained data, wherein each of the candidate prescription strings is associated with a plurality of attributes;
automatically processing each of the one or more candidate prescription strings based on at least one model to generate one or more prescription strings each with an associated ranking; and
storing at least some of the generated one or more prescription strings and the associated rankings for future use.

2. The method of claim 1, further comprising:
providing the stored one or more prescription strings with the associated rankings to facilitate automatic recommendation of prescription strings.

3. The method of claim 2, wherein the step of providing is via a portal upon a request.

4. The method of claim 2, wherein the step of providing is via an application programming interface (API).

5. The method of claim 2, wherein the step of providing is via a flat file.

6. The method of claim 1, further comprising:
receiving an input, wherein the input is resulted from a single action of a user and associated with a least one parameter;
identifying at least some of the stored prescription strings with their attributes matched with the at least one parameter; and
recommending the identified prescription strings based on their associated rankings.

7. The method of claim 6, wherein the parameter comprises at least one of a medication, a diagnosis, and a treatment.

8. The method of claim 6, further comprising:
receiving a feedback with respect to the recommended prescription strings.

9. The method of claim 1, wherein the data related to medication drugs comprises at least one of:
data related to prescription transactions; and
knowledge related to medication drugs.

10. The method of claim 1, wherein the step of automatically processing comprises:
normalizing the one or more candidate prescription strings based on a first model;
de-duplicating the normalized one or more candidate prescription strings;
calculating a confidence score for each of the de-duplicated prescription strings based on a second model; and
ranking the de-duplicated prescription strings based on their confidence scores.

11. The method of claim 10, wherein the first model comprises at least one of:
a contextualized mapping model,
a dose conversion model,
a liquid dose conversion model, and
a quantity/duration alignment model.

12. The method of claim 10, wherein the second model is a statistics model.

13. The method of claim 1, wherein the step of storing comprises:
selecting the at least some of the one or more prescription strings based on an input; and
archiving the at least some of the one or more prescription strings in a database, wherein the input is determined based on a human review and/or automatic comparison between the at least some of the one or more prescription strings and approved prescription strings.

14. The method of claim 1, wherein the plurality of attributes associated with a prescription string comprise: medication drug ID, action, dose, unit, route, duration, timing, dispensing, dispensing quantity, related diagnosis, and related treatment.

15. A method, implemented on at least one computing device each of which has at least one processor, storage, and a communication platform connected to a network for recommending prescription strings, the method comprising:
receiving a request for recommending a prescription string, wherein the request is resulted from a single action of a user and associated with a least one parameter;
identifying at least one prescription string stored previously, each of which has a plurality of attributes that match with the at least one parameter; and
providing the at least one prescription string as recommendation for the request.

16. The method of claim 15, wherein
each of at least one prescription string is with an associated ranking; and
the at least one prescription string is provided based on their rankings.

17. The method of claim 15, further comprising:
obtaining data related to a medication drug;
identifying one or more candidate prescription strings from the obtained data;
automatically processing each of the one or more candidate prescription strings based on at least one model to generate the at least one prescription string each with an associated ranking; and
storing the at least one prescription string and the associated rankings.

18. A system, having at least one processor, storage, and a communication platform connected to a network for generating prescription strings, the system comprising:
a data analyzer configured to obtain data related to a medication drug and identify one or more candidate prescription strings from the obtained data, wherein each of the candidate prescription strings is associated with a plurality of attributes;
an analytic engine configured to automatically process each of the one or more candidate prescription strings based on at least one model to generate one or more prescription strings each with an associated ranking; and
a re-contextualizing unit configured to store at least some of the generated one or more prescription strings and the associated rankings for future use.

19. The system of claim 18, further comprising:
a deployment engine configured to provide the stored one or more prescription strings with the associated rankings to facilitate automatic recommendation of prescription strings.

20. The system of claim 19, wherein the stored one or more prescription strings are provided via at least one of: a portal upon a request, an API, and a flat file.

21. The system of claim 18, further comprising an e-prescription portal system configured to:
receive an input, wherein the input is resulted from a single action of a user and associated with a least one parameter;
identify at least some of the stored prescription strings with their attributes matched with the at least one parameter; and
recommend the identified prescription strings based on their associated rankings.

22. The system of claim 21, wherein the parameter comprises at least one of a medication, a diagnosis, and a treatment.

23. The system of claim 21, wherein the at least one processor is further configured to receive a feedback with respect to the recommended prescription strings.

24. The system of claim 18, wherein the data related to medication drugs comprises at least one of:
data related to prescription transactions; and
knowledge related to medication drugs.

25. The system of claim 18, wherein the analytic engine comprises:
a data normalizer configured to normalize the one or more candidate prescription strings based on a first model;
a string de-duplicator configured to de-duplicate the normalized one or more candidate prescription strings;
a confidence level calculator configured to calculate a confidence score for each of the de-duplicated prescription strings based on a second model; and
a ranking unit configured to rank the de-duplicated prescription strings based on their confidence scores.

26. The system of claim 25, wherein the first model comprises at least one of:
a contextualized mapping model,
a dose conversion model,
a liquid dose conversion model, and
a quantity/duration alignment model.

27. The system of claim 25, wherein the second model is a statistics model.

28. The system of claim 18, wherein the analytic engine further comprises:
a quality control unit configured to select the at least some of the one or more prescription strings based on an input; and
the re-contextualizing unit configured to archive the at least some of the one or more prescription strings in a database, wherein the input is determined based on a human review and/or automatic comparison between the at least some of the one or more prescription strings and approved prescription strings.

29. The system of claim 18, wherein the plurality of attributes associated with a prescription string comprise: medication drug ID, action, dose, unit, route, duration, timing, dispensing, dispensing quantity, related diagnosis, and related treatment.

30. A system, having at least one processor, storage, and a communication platform connected to a network for recommending prescription strings, the at least one processor is configured to:
receive a request for recommending a prescription string, wherein the request is resulted from a single action of a user and associated with a least one parameter;
identify at least one prescription string stored previously, each of which has a plurality of attributes that match with the at least one parameter; and
provide the at least one prescription string as recommendation for the request.

31. The system of claim 30, wherein:
each of at least one prescription string is with an associated ranking; and
the at least one prescription string is provided based on their rankings.
